(19) United States
(12) Patent Application Publication
(10) Pub. No.: US 2025/0203425 A1
(43) Pub. Date: Jun. 19, 2025

(54) GENERATING SERVICE-CHAINED PROBE DATA FOR A CELLULAR NETWORK

(71) Applicant: DISH Wireless L.L.C., Englewood, CO (US)

(72) Inventors: Mostafa Tofighbakhsh, Cupertino, CA (US); Arash Mahmoudian, Littleton, CO (US); Mahdi Khansari, Littleton, CO (US)

(21) Appl. No.: 18/542,462

(22) Filed: Dec. 15, 2023

(51) Int. Cl. H04W 24/10; H04L 69/22

(52) U.S. Cl. CPC H04W 24/10; H04L 69/22

(57) ABSTRACT

Technologies for providing service-chained probe data in a cellular network are described. One method includes obtaining a request from a northbound application in a cellular network for service-chained probe data. The method further includes obtaining data from a first and second network probe, configured to report on conditions at a first and second resource of the cellular network. The method further includes generating the service-chained probe data based on the probe data. The method further includes providing the service-chained probe data to the northbound application.

### BACKGROUND

Telecommunication networks, such as cellular networks, have various resources that produce data and metadata concerning operations of the cellular network. A customer, such an enterprise customer, of a cellular network does not have access to the data and metadata generated by the network resources of the cellular network. A cellular network may have a variety of probes associated with various network components for providing data indicative of performance of the network. However, customers may not have control over design or implementation of probes that may report on target performance indicators. Such customers could benefit from obtaining data (such as service-chained probe data related to measurements of multiple probes) in a meaningful and insightful way to manage usage or configuration of network resources in the cellular network.

One type of cellular network is a Fifth generation (5G) wireless network. In a 5G wireless network, a 5G Standalone Core Network (5G SA core) is responsible for managing and routing data traffic, providing various network resources and services, and supporting the core functionalities of a 5G network. The term “SA” stands for “Stand-Alone,” indicating that this core network operates independently of any existing 4G (LTE) infrastructure. 5G wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times. A control plane may include a part of a network that controls how data packets are forwarded or routed. The control plane may be responsible for populating routing tables or forwarding tables to enable data plane functions. A data plane (or forwarding plane) may include a part of a network that forwards and routes data packets based on control plane logic. Control plane logic may also identify packets to be discarded and packets to which a high quality of service should apply. 5G wireless user equipment (UE) may communicate over both a lower frequency Sub-6 GHz band between 410 MHz and 7125 MHz and a higher frequency mm Wave band between 24.25 GHz and 52.6 GHz. As described above, various resources and services of the 5G wireless network are not accessible to a customer for optimizing usage and configuration of these resources in a meaningful and insightful way.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of a service-chained probe data platform including an intelligent data collector, according to some embodiments.

FIG. 2 is a block diagram of a platform for generating service-chained probe data form a probe data fabric, according to some embodiments.

FIG. 3A is a flow diagram of a method for providing service-chained probe data to a target application, according to some embodiments.

FIG. 3B is a flow diagram of a method for providing service-chained probe data, according to some embodiments.

FIG. 4 is a flow diagram a method for generating data output based on a data fabric of probe data, according to some embodiments.

FIG. 5 illustrates a model training workflow and model application workflow for cellular network data, according to some embodiments.

FIG. 6 depicts a 5G network including a radio access network (RAN) and a core network according to at least one embodiment.

FIGS. 7-8 depict a radio access network and a core network for providing a communications channel (or channel) between user equipment and data network according to various embodiments.

FIG. 9 depicts network functions interacting between user and control planes according to at least one embodiment.

FIG. 10 depicts network functions interacting between user and control planes according to at least one embodiment.

FIG. 11A depicts network slices sharing a set of shared core network functions according to at least one embodiment.

FIGS. 11B-C depict network slices after updates have been made based on changed to the network slice policy according to various embodiments.

FIG. 12A-FIG. 12D depicts a radio access network according to various embodiments.

FIG. 12E depicts a core network according to at least one embodiment.

FIG. 12F depicts a containerized environment that includes a container engine running on top of a host operating system according to at least one embodiment.

FIG. 13A-FIG. 13D depict a 5G network including implementations of a radio access network and a core network with virtualized network functions arranged within a data center hierarchy according to various embodiments.

### DETAILED DESCRIPTION

Technologies for providing service-chained probe data to users of a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

There are new and emerging applications with time sensitive features that could provide significant actionable data to users of a wireless network. However, as described above, a customer or user of a cellular network may not have an ability to determine which probes, measurements, or the like are included in the network. The user may receive the data and metadata generated by the resources of the cellular network, but without the ability to customize what measurements are made or what data is received. Conventionally, some data can be provided to a user using a log file. This data would not be considered a real-time measurement context of the cellular network for any dynamic control of the underlying resources by the user. Further, a network may include many probe functions (e.g., on the order of thousands) which may produce a volume of data that is inconvenient, computationally prohibitive, or impossible to search for insights into improving parameters of the cellular network. For example, some cellular networks may generate terabytes of probe data per day. Conventionally, there are no mechanisms to enable a customer to obtain data in a meaningful and insightful way to manage usage or configuration of network resources in the cellular network.

Aspects and embodiments of the present disclosure address the above and other deficiencies by providing an adaptive service-chained probe data generation platform that may provide customized service-chained probe data to a customer or user of a cellular network. In some embodiments, a cellular network may include a number of probes for measuring various conditions of the network. The probes may be designed, selected, generated, installed, etc., by one or more designers, engineers, or other personal associated with physical and/or digital architecture of the cellular network, e.g., customers or consumers of the cellular network may not be involved in implementation of probes for measuring conditions of the network. Probes may exist for measuring any number of properties of a cellular network, including data flow properties, connectivity properties, radio characteristics, or the like. Probes may be included in various components of a cellular network, such as radios (e.g., RANs), distributed units, central units, data transport layers, control planes, or the like. In some networks, the number of probes may be quite large, e.g., hundreds, thousands, or more probes may exist in association with a cellular or wireless network. One or more properties of interest to a cellular network user may not be immediately available by probe data. Further, properties of interest may be obscured by a volume of probe data generated by a cellular network. However, it may be possible to determine properties of interest of the network by combining measurements of two or more probes. One or more key indicators of network performance may be available based on output of multiple probes. In some embodiments, a function performed on probe data (e.g., a polynomial function) may provide a target indicator of network performance. In some embodiments, providing probe data to one or more algorithms or models may provide a target indicator of network performance. In some embodiments, providing probe data to one or more statistical models may provide a target indicator of network performance. In some embodiments, providing probe data to one or more trained machine learning models may provide a target indicator of network performance.

One or more applications of an upper layer (e.g., executed via processing devices associated with a software defined network of a 5G cellular network, a northbound application, etc.) may interface with probes of the cellular network to generate service-chained probe data, e.g., for providing one or more target performance indicators of the cellular network. In some embodiments, a northbound application may receive probe data, e.g., via one or more application programming interfaces (APIs) of the cellular network. In some embodiments, a northbound application may be executed by one or more processing devices of the cellular network, e.g., via software defined network processing. In some embodiments, a northbound application may be executed by one or more processing devices that are not of the cellular network, e.g., a user or technician may execute the northbound application on a client device, a tablet, a laptop, a smart phone, or the like. In some embodiments, a northbound application may provide instructions to one or more probes of the network. Instructions may include instructions to provide data to the northbound application. Instructions may include instructions related to data collection, such as a target time of data collection, frequency of data collection, duration of data collection, or the like. Instructions may relate to data generation, such as instructions to include one or more data tags in probe data. Data tags may enable or assist an application in determining which probe data to analyze, in analysis operations, or the like. Data tags may include indications of conditions of data collection, conditions of the cellular network, conditions affecting operations of the cellular network, or the like. Data tags may include indications of a time of measurement, of a type of data packet included or measures, of a size of data packet measured, an identifier of an associated northbound application (e.g., an application that requested a probe measurement), one or more conditions affecting network hardware such as weather conditions, maintenance, conditions, or the like, etc.

In some embodiments, a northbound application may provide a request for service-chained probe data. The request for service-chained probe data may include a request for probe data from two or more probes to be provided. The request for service-chained probe data may include a request for probe data to be manipulated, e.g., by one or more functions, by providing probe data to a trained machine learning model, or the like. In some embodiments, the northbound application may perform analysis and/or manipulation of probe data, of composite probe data (e.g., probe data that has been analyzed or manipulated previously, or the like).

Data may be received from two or more probes of the cellular network. The probes may be associated with one or more resources of the cellular network. In some embodiments, a first probe may be associated with a first cellular network resource and a second probe may be associated with a second cellular network resource. The probe data may be associated with a single action, event, time period, function, or the like of the cellular network. Tagging of data by the probes may enable correlation of data from different probes, determination of correspondences between data from different probes, etc.

Service-chained probe data may be generated based on the probe data received. Service-chained probe data may be data output from one more models, algorithms, functions, or the like which are provided with probe data (and, in some embodiments, tag data) as input. Service-chained probe data may include one or more performance indicators. Service-chained probe data may include one or more predicted deficiencies of cellular network performance. Service-chained probe data may include one or more predicted root causes of deficiencies of cellular network performance. Service-chained probe data may include one or more recommended actions to be performed based on performance of the cellular network.

In some embodiments, service-chained probe data may be generated based on probe data and historical data. For example, similarities between historical data indicative of a particular cellular network deficiency and current probe data may be utilized in predicting presence of the cellular network deficiency, differences between historical data indicative of a particular cellular network deficiency and current probe data may be utilized in predicting that the network deficiency is not present, etc. Historical data may be utilized in combination with rule-based models, statistical models, machine learning models (in training and/or inference operations of the machine learning models), etc. In some embodiments, performance indicator values may be determined in association with current probe data and historical probe data. In some embodiments, a performance indicator value may be based on historical and current data, e.g., a difference between a historical and current performance indicator value or another relationship between the historical probe data and current probe data.

In some embodiments, service-chained probe data may be generated by a trained machine learning model based on a fabric of probe data. For example, a set of probes may provide a data fabric (e.g., a matrix or another form of storing and/or organizing data). The data fabric may include a large amount of data. The data fabric may include data from all probes of a cellular network, all probes selected in association with a target network performance failure, all probes associated with a target network facility or architecture, a subset of these probes, or the like. The data fabric may include a large amount of data. A machine learning model may be trained to generate predictive data responsive to receiving a data fabric as input. Training the machine learning model may include providing data fabrics labeled with one or more network failures, malfunctions, or instances of performance that do not satisfy one or more target threshold performance conditions.

In some embodiments, a machine learning model trained or configured to generate predictive data (e.g., predicted network performance conditions, predicted network performance root causes, predicted corrective actions to improve network performance, or the like) based on data fabric input may enable actions to be taken based on large, non-linear, correlated data sets. Information may be extracted from data fabrics that are not available from a single probe, e.g., the machine learning model may generate and/or form predictions based on service-chained probe data of the cellular network. In some embodiments, data of the data fabric may include data from a target duration of time. Data of the data fabric may include data tagged by probes of the cellular network. The trained machine learning model may utilize data of the fabric, relationships between data, information included in data tags, etc., for generating predictive data.

Aspects and embodiments of the present disclosure can provide a logical service-chained probe data pipeline for third-party applications (e.g., 5G northbound applications) executing in connection with the cellular network. Aspects and embodiments of the present disclosure can enable third-party enterprise applications to leverage O-RAN centric wireless networks to get additional insights for verticals such as health care, Vehicle-to-Everything (V2X), Extended Reality (XR), immersive applications, or the like. V2X is a term used in the automotive and transportation industry to describe communication technology that allows vehicles to communicate with various elements of the surrounding environment. This includes communication between vehicles (V2V), between vehicles and infrastructure (V2I), between vehicles and pedestrians (V2P), and more. V2X technology is designed to enhance road safety, traffic efficiency, and overall transportation systems by enabling vehicles to share information about their status, location, and intentions with other vehicles and infrastructure. XR is a term that encompasses virtual reality (VR), augmented reality (AR), mixed reality (MR), and other immersive technologies that combine the physical and digital worlds to create immersive and interactive experiences. These technologies are used in various applications, including gaming, training and simulation, healthcare, education, architecture, and more. The service-chained probe systems can collect data and provide insights as a real-time measurement context of the cellular network to the various applications. The various applications can use the real-time measurement context of the cellular network for dynamic control of one or more resources or services of the cellular network. A customer can use the insight data (i.e., the real-time measurement context) provided by the service-chained probes. In particular, aspects and embodiments of the present disclosure can provide a real-time measurement context to one or more network slices serving customer or user of the cellular network.

Aspects and embodiments of the present disclosure can provide specialized virtualized artificial intelligence or machine learning (AI/ML) enabled service-chained probes to third-party enterprise applications in different verticals. Service-chained probe data can play a role in addressing a variety of vertical applications that need mission critical insights from the cellular networks that serves them. Aspects and embodiments of the present disclosure can help these new and emerging applications with time sensitive features by providing more context (e.g., real-time context) to their downstream customers.

It should be noted that 5G and emerging 6G network architectures are based on the concept of virtual network functions. Aspects and embodiments of the present disclosure can cause the virtual network functions use run-time probes to collect data from data source in the cellular network and interact with additional embedded AI/ML inferences The data sources can be raw counters, logs, events, metrics, traces, alarms, configuration data, flow data, state information, error messages, or the like. A probe agent located at these data sources can be used to collect data items that are aggregated, filtered, or further processed before being input into the AI/ML inferences.

Aspects and embodiments of the present disclosure can obtain input data for the AI/ML inference(s) using probe templates, and the AI/ML inference(s) can provide output data, such as key performance indicators (KPIs) or states of network resources of the cellular network. The KPIs and states can be aggregated by higher interfaces, transfer functions, third-party applications, or the like. These application can be serving their own verticals, leveraging the network primitives, probe functions, and service-chained probes. For example, a monetizable application of a 5G wireless network needs to collect measured sensor information from the 5G wireless network to provide insights into the services they provide to their respective customers. In some cases, there can be a first service-chained data generation pipeline for an XR application, a second service-chained data generation pipeline for a V2X application, a third service-chained data generation pipeline for a manufacturing application, a fourth service-chained data generation pipeline for a healthcare application, and the like. The respective service-chained data may be utilized to provide insights into the respective services they provide to their respective customers. The service-chained data platform can provide these applications with real-time or near-real-time measured data. The real-time or near-real-time measurements can be collected using embedded run-time probe agents, network primitives at the network functions, or the like. The service-chained data platform can utilize the AI/ML inferences virtual switch function to accelerate coordinated measurements among the distributed probe agents and provide a real-time or near-real-time response to northbound applications via their application programming interfaces (APIs) exposed on the northbound of the service-chained probe data platform.

The probe templates can assist the applications to be aware of what data context could be available to collect, as well as the AI/ML methods available to process the collected data for observation. It is through these probe templates that the applications can populate their context aware intents and the service-chained probe data platform can respond to them accordingly to their set parameters in the probe templates. For example, a collective logical radio service-chained probe data platform can operate as a monetization platform to serve third-party 5G enterprise applications. In this context, the service-chained probe data generation pipeline can be broken down into fundamental measurement primitive components, allowing third-party applications to mix and match APIs and probe template components into a single service chain to meet their needs. An observability application, which may need to compute a set of real-time or near-real-time KPIs or an observability function, obtains one or more probe templates for generating appropriate live network data sets or counters from data stores (e.g., data lakes) through the observability platform northbound interface. The observability application can use the API for collecting appropriate data probes, counters, logs, events for controlling and monitoring the real-time desired probes and KPIs for a period of time set by the probe template. The service-chained probe data platform can provide additional synchronization and scheduling or probe functions that can bring back additional context for the time-sensitive verticals. In at least one embodiment, the probe template can be populated with natural language from a customer, and a probe controller can have natural language processing to process the natural language to define the set of programmable parameters for a service-chained probe data platform. The probe template can be considered expanded sets of APIs for collecting specific data, aggregating data from disparate sources, obtaining specific insight data from the collected data, and providing the insight data to one or more northbound application that use the insight data for additional operations, such as presenting on a dashboard, inputs to an analytics engine, output alerts and notification, etc.

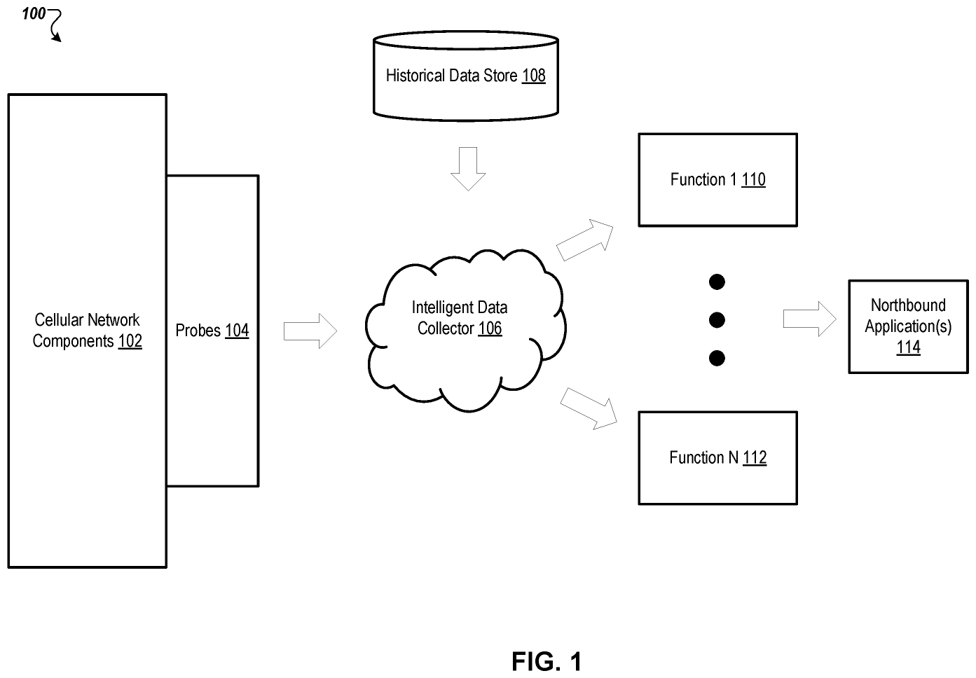

FIG. 1 is a block diagram of a service-chained probe data platform 100 including an intelligent data collector 106, according to some embodiments. Platform 100 includes probes 104, which are associated with cellular network components 102. Probes 104 may provide probe data to intelligent data collector 106. Intelligent data collector may further receive data from historical data store 108, e.g., for comparing historical measurement data to current measurement data collected from probes 104. Intelligent data collector 106 may further provide data to any number of functions, e.g., function 1 110 through function N 112. Data manipulated, analyzed, or output by functions 1 through N may be provided to one or more northbound applications 114 for further operations. Multiple components of platform 100 may have functions executed by processing devices, data storage devices, or other devices associated with the cellular network, e.g., cellular network components 102. Components of platform 100 may be performed by software applications, software components, hardware components, general computing devices, purpose-built computing devices, virtual machines, cloud-based computing architecture, or the like. In some embodiments, one or more components of platform 100 may be executed as part of a software-defined cellular network, e.g., any or all of the components of platform 100 may be a part of a software-defined network.

The probes 104 may be physical sensors, digital sensors, software defined data collectors, or the like, for measuring conditions of one or more cellular network components 102. Each of the probes 104 may be associated with one or more components of cellular network components 102. Probes may be configured to measure one or more conditions of any component of a cellular network, including physical components (e.g., radios, processing devices, data storage devices, or the like), digital components (e.g., data transport layer, control plane, or the like), components that may be executed by hardware or software, components executed by cloud processing systems, or the like. The probes 104 may perform measurement operations based on instructions received from another component, e.g., intelligent data collector 106. Probes 104 may perform operations that are programmable, such as a time, duration, frequency, or the like of measurement. Probes 104 may be programmed to provide additional data with measurement data, including data tags, metadata, decorated data, or the like. Probes 104 may receive instructions for executing measurement from intelligent data collector 106 and/or other components of platform 100.

In at least one embodiment, a probe is a software component, code, or other mechanism used in computing and system monitoring to collect information about the behavior and performance of a network resource, such as one of the components of cellular network components 102, an infrastructure resource, a sensor, a UE, or the like. The probe can be a hardware circuit, a software probe, a virtual probe, or the like. The probe can collect specific data points or metrics from various parts of a system. The probe can collect information from a counter, a log, an event, a stored metric, a trace, an alarm, configuration data, flow data, state information, error messages, or the like. For example, the probe can collect metrics like central processing unit (CPU) usage, memory usage, network traffic, disk input/output (I/O), etc. The probe can continuously sample or measure, at a specified rate, these metrics and make them available for monitoring and analysis. The probe can be used for understanding the current state and health of network resources of the cellular network. A counter, for example, is a type of metric used to keep track of cumulative values over time, such as to count events or occurrences. The counter can be useful for measuring the frequency or rate of events and can provide insights into trends and patterns. A log, for example, can be a textual record generated by the respective resource. The log can capture important information, events, and actions taken by a system. Logs are often used for troubleshooting, auditing, and monitoring. They can contain various types of data, including timestamps, error messages, user actions, and more. An event can be a discrete occurrence or incident that has significance within the resource. Events can represent various types of activities, such as user interactions, system state changes, or errors. Metrics can be quantitative measurements or values that provide insight into the performance, health, or state of a system or application. They can include CPU utilization, memory usage, network bandwidth, response time, and more. Metrics can typically be collected over time to track trends and detect anomalies. Traces can be detailed records of individual transactions or events within a system. They include information about the sequence of actions taken, timestamps, and data associated with each event. Traces can be valuable for diagnosing performance issues and understanding the flow of data or requests through a system. Alarms or alerts can be notifications triggered when specific conditions or thresholds are met. For example, an alarm might be raised when CPU usage exceeds a certain threshold or when a security breach is detected. Alarms are used to notify administrators or automated systems of significant events. Configuration data can include settings, parameters, and configuration files that define how a system or application should behave. It can encompass network configurations, application settings, hardware settings, and more. Changes to configuration data can have a significant impact on system behavior. Flow data, often used in network monitoring, can represent the records of data flows between network devices. It includes information about source and destination IP addresses, port numbers, protocols, and the amount of data transferred. Flow data is useful for analyzing network traffic patterns. State information can represent the current state or condition of a system or application. It includes variables, flags, and data structures that capture the system's status. State information is crucial for maintaining context and continuity in distributed systems. Audit logs can be records of actions and activities performed by users or systems. They are often used for security and compliance purposes, providing a detailed history of who did what and when. Audit logs are crucial for investigating security incidents and maintaining accountability. Performance counters can be specialized metrics that focus on system performance and resource utilization. They can include CPU cycles, memory paging rates, disk I/O operations, and network packet rates. Performance counters are used for fine-grained performance analysis. In network analysis, packet captures (or packet traces) can contain raw network packets, including their headers and payloads. Packet captures are used to inspect network traffic at a granular level, diagnose network issues, and investigate security incidents. Error messages can be notifications generated by systems or applications to indicate that something has gone wrong, or an unexpected condition has been encountered. Error messages often contain diagnostic information to help troubleshoot issues. These data items play essential roles in monitoring, troubleshooting, and optimizing systems, networks, and applications. The choice of which data items to collect and analyze depends on the specific goals and requirements of the monitoring and analysis tasks.

Data provided by probes 104 may be tagged or decorated, etc., with additional information associated with the measurements made by the one or more probes. Probes may tag or decorate data to provide additional information not included in the data. Data tags may include information contextualizing the data provided by the proves. Data tags may include information about the data measurements (e.g., time of measurement, duration of measurement, etc.), information about the data (e.g., size or type of data packet), information indicative of data destination or use (e.g., an identifier of a function the data is to be provided to, an identifier of a northbound application the data is to be provided to, or the like), information identifying a condition of the cellular network (e.g., weather conditions, cellular traffic conditions, radio conditions, etc.), or the like.

In some embodiments, data tags provided to probe data from probes 104 may enable intelligent data collector 106 to perform target actions with the probe data. For example, data tags may enable intelligent data collector 106 to group probe data from various probes 104 together for delivery, provide probe data to the correct function or functions, collect the probe data and related historical data from historical data store 108, perform one or more operations on the probe data, or the like.

Historical data store 108 may include sets of historical data for use by intelligent dat collector 106, various functions, northbound applications 114, etc., in combination with data from probes 104 for determining conditions of a cellular network, recommended corrective actions, or the like. Historical data 108 may be related to or correspond to data from probes 104. Historical data 108 may include additional information, such as labels corresponding to root causes of inadequate performance of the cellular network, performance metrics of the cellular network, conditions of the cellular network, or the like. For example, historical data 108 may include sets of probe data associated with dropped calls, poor service quality, or other instances of cellular network performance failing to meet threshold performance conditions. Intelligent data collector 106 may obtain historical data from historical data store 108 that may be utilized in determining whether current probe data is indicative of a conditions of the cellular network included in the historical data. In some embodiments, historical data may be utilized for training or configured one or more functions, machine learning models, or the like. In some embodiments, historical data may be utilizing in inference operations of one or more functions, machine learning models, or the like. In some embodiments, correlation with historical data (including by models trained or configured using historical data, as well as methods including providing historical data as input) may be performed in real time or near-real time, which may enable enactment of one or more corrective actions quickly for improvement of service quality of the cellular network. Historical data may be utilized via machine learning or artificial intelligence modeling, statistical modeling, heuristic or rule-based modeling, or the like. In some embodiments, historical data may be tagged with one or more descriptors. In some embodiments, descriptors may be provided in natural language, and a user and/or a language-interpretation model (e.g., a machine learning model) may determine applicability of historical data, classification of the historical data, or the like based on the descriptors.

In at least one embodiment, a probe template can be populated with natural language from a customer, and a northbound application 114 and/or intelligent data collector 106 can have natural language processing to process the natural language to define the set of programmable parameters for generating service-chained probe data. The probe template could have any of the following examples of demands in the requests:
1. Show me all the UEs active on Slice X, Y
2. Show me all the video or voice or data packet data unit (PDU) sessions on specific slice
3. Slice level Probe as a Service provides for customized self-defined probes
4. Provide Real Time Analytics from defined Probes at atomic level
5. Enable Dedicated Enterprise 5G probes mapped to their optimization policies
6. Load balancing among executing logical probes against available slices
7. Utilize probes to Track enterprise customers specific Device Behaviors
8. Enable Dedicated 5G Enterprise Data collection from slice user planes as a services
9. Putting Enterprise customers in charge of their 5G private Data PDU sessions within RAN slices

Data from one or more of probes 104, as well as historical data in some embodiments, may be provided by intelligent data collector 106 to one or more functions, e.g., function 1 110 through function N 112. In some embodiments, intelligent data collector 106 may determine whether to provide data to one or more functions. For example, intelligent data collector 106 may be configured to provide probe data to function 1 110 under one or more conditions. Intelligent data collector 106 may be configured to provide probe data to a function only if the probe data satisfies a target condition, only if a correlation between the probe data and historical data satisfies a target condition, or the like. In some embodiments, intelligent data collector 106 may provide data to a first function if one or more conditions are satisfied, to a second function if a different one or more conditions are satisfied, etc.

Data output by one or more functions may be provided to northbound applications 114. Northbound applications 114 may be configured to perform actions based on output data received from the one or more functions. Northbound applications may be configured to perform corrective actions for the cellular network based on data received from the functions. Northbound applications 114 may be configured to provide alerts to one or more users based on data received from the functions. Northbound applications 114 may be configured to perform reporting operations, may be included in a feedback loop for operations of the cellular network, or the like. Northbound applications 114 may be configured to perform corrective actions such as adjusting power output of one or more radios of the cellular network, adjusting antenna tilt or directionality of one or more antennas of the cellular network, adjusting radio resource allocation, adjusting computing device (processing device) resource allocation, adjusting one or more network slices, or the like. In some embodiments, northbound applications may be executed by a static computing device, e.g., a device associated with the cellular network, a virtual or cloud-based device associated with the network, or the like. Delivery to the northbound applications 114 may be performed via providing data to another application executed by the same hardware (or set of hardware, e.g., computing devices, processing devices, etc.) as one or more probes, cellular network components, intelligent data collector, functions, or the like. Delivery to northbound applications 114 may include providing and/or transmitting data to one or more processing devices outside the cellular network architecture, such as a client device of a subject matter expert, engineer, technician, or the like. As an example, a technician may carry a tablet computer for performing operations associated with maintenance, quality assurance, or the like of the cellular network, and a northbound application may be executed on the tablet in association with service-chained probe data. Such delivery may be performed by an application programming interface or another method of data delivery. Service-chained probe data may be provided, sent, transmitted, transferred, or otherwise delivered to the device that is separate from devices of the cellular network. Delivery may be to a specific target device, to a device associated with a user, to a device associated with a user account, or the like.

In at least one embodiment, the service-chained probe data can be used for a logical radio resource abstraction for an enterprise with dedicated northbound applications. In some embodiments, the northbound application can contain centralized log management and analysis tools to process and search through large volumes of logs for additional insights, debugging, optimizations, or the like. In some embodiments, the northbound application can contain event-driven systems and architectures that rely on events to trigger specific actions or processes. Events can be logged for monitoring and analysis, and they are also a fundamental concept in event-driven programming and event sourcing.

In at least one embodiment, the service-chained probe data may be provided via one or more APIs to enable customizable self-defined probe collectors and/or probe agents, which can also be wrapped in APIs for further programmability. In at least one embodiment, the service-chained probe platform, including the APIs and their functionalities, can be packaged in a Near-Real-Time Radio Intelligent Controller (Near-RT RIC). A Near-RT RIC is a key component in the architecture of modern 5G (and beyond) mobile networks, specifically within the context of open, software-defined, and virtualized network architectures. “Near-Real-Time” means that the controller operates with minimal latency or delay, allowing for rapid decision-making and control of radio resources. In 5G and future networks, low latency is crucial for supporting applications like autonomous vehicles, augmented reality, and ultra-reliable communication. The Near-RT RIC is specifically designed to operate with very low latency, often in the order of milliseconds, to ensure that it can respond quickly to changing network conditions and traffic demands. It is a key component in enhancing the performance and efficiency of the radio access network in 5G and future networks. The Near-RT RIC can be thought of as part of the broader movement towards open and virtualized network architectures, such as O-RAN (Open Radio Access Network), where network functions are disaggregated, and software-driven controllers play a central role in optimizing and managing network resources. It helps network operators adapt to the dynamic and diverse requirements of modern wireless communication while improving the overall performance and efficiency of the network. In at least one embodiment, various components of platform 100, including the APIs and their functionalities, can be packaged in a non-RT-RIC.

In some embodiments, northbound applications 114 may provide instructions to intelligent data collector 106 or other components of platform 100 for data collection, delivery, or the like. For example, northbound applications 114 may provide instructions regarding probe data of interest, historical data of interest, functions of interest, or the like. In some embodiments, northbound applications 114 have one or more associated user interfaces (e.g., graphical user interfaces) for requesting data collection, function performance, generation of new functions, delivery of service-chained probe data, or the like.

In some embodiments, requests for service-chained probe data (e.g., requests provided by northbound applications 114) may be generated with actions of one or more machine learning models. In some embodiments, a language model may be utilized to process user inputs via northbound applications 114. For example, a machine learning model may interpret user requests formulated in language as functional combinations of probe data, and transmit instructions to intelligent data collector 106 to program one or more probes, receive probe data, receive historical data, provide data to one or more functions, etc., based on the language-based request.

The intelligent data collector 106 can collect, process, and enrich input data received from probes 104 in real-time or near-real-time. The intelligent data collector 106 can use various transform functions, aggregators, or the like, to join data from various data sources, and persist them in time-series databases (TSDBs). For example, first probe can collect first data, and second data can be collected from a second probe from an associated component of cellular network components 102. The second data can be part of a slice within the cellular network. The different types of data sources can be data probes, counters, logs, events, or mechanisms used in computing and system monitoring. The intelligent data collector 106 can gather information and determine insights about the behavior and performance of network resources in a cellular network, including software systems and applications.

As described herein, the intelligent data collector 106 can provide one or more probes-as-services in the cellular network. The intelligent data collector 106 can receive, from a user, a request for a service-chained probe data in the cellular network. The intelligent data collector 106 can provide a probe delivery diversification service. The diversification service can be provided at a slice level. For example, a first slice can be controlled by a first set of programmable probe collectors, and a second slice can be controlled by a second set of programmable probe collectors. The intelligent data collector can provide a first service-chained probe data including data from a first set of programmable probes for data collection to the first slice and a second set of service-chained probe data with data of a second set of data from programmable probe collectors to the second slice.

In at least one embodiment, a request from northbound applications 114 for service-chained probe data can include a probe data template. The probe template can have a set of programmable parameters that specify various aspects of the service-chained probe data. For example, a first parameter of a probe template can specify a set of one or more probe collectors to collect input data. A second parameter of the probe template can specify one or more ML models (e.g., ML engines provided by a network provider) to process input probe data to obtain output data. The second parameter can specify other network provider dedicated tools, methods, and APIs to other functions to process the input data. A third parameter of the probe template can specify a northbound application to receive the observation data, notifications associated with the observation data, alarms associated with the observation data, or the like, via APIs. In some cases, the northbound application can include or be a dashboard, a transfer function, an analytics application, a graphical user interface, and/or a second ML model. The third parameter could also be specify a related offer associated with the observation data.

In at least one embodiment, the service-chained probe data can be used for device level probes such as for location and behavior boundaries corelated with network provided resources. The service-chained probe data can be used for other similar and dissimilar use cases that are not necessarily described herein.

In some embodiments, intelligent data collector 106 may determine a set of functions or applications to provide probe data to. For example, intelligent data collector 106 may recognize that multiple applications are requesting data from a probe, and may provide the data to multiple functions, and/or the multiple applications to satisfy the requests.

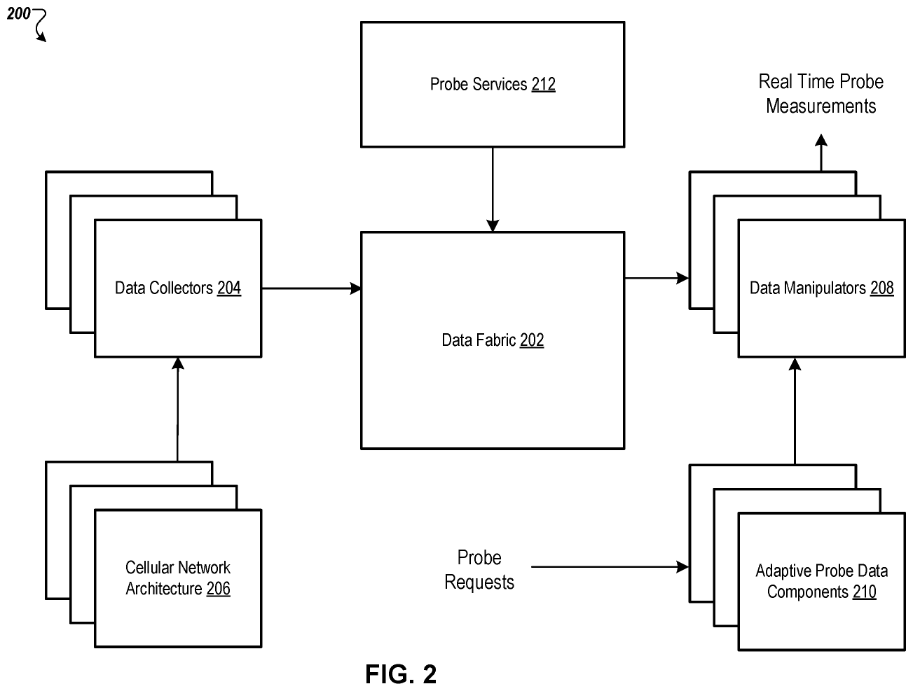

FIG. 2 is a block diagram of a platform 200 for generating service-chained probe data from a probe data fabric 202, according to some embodiments. Platform 200 may include various software packages, applications, and models, as well as physical hardware. FIG. 2 includes arrows showing data communication direction for some embodiments, however, communication may proceed between different components of platform 200, in different directions than depicted in FIG. 2, or the like.

Platform 200 includes cellular network architecture 206 (e.g., cellular network components 102 of FIG. 1), data collectors 204 (e.g., probes 104 of FIG. 1), data fabric 202, probe services 212, data manipulators 208, and adaptive probe data components 210.

In some embodiments, a data fabric 202 may be generated based on probe data, data received from data collectors 204, input from probe services 212, etc. Data collectors 204 (e.g., probes) may measure one or more conditions of components of cellular network architecture 206 (e.g., radio access network, software-defined network, etc.) to generate probe data. In some embodiments, a large number of probes may generate data. Service-chaining of data from multiple probes via one or more functions may greatly increase the amount of data to be generated, stored, provided to one or more models for further analysis, etc. For example, various permutations of a few sets of probe data may provide insights into different performance conditions of the cellular network (e.g., key performance indicators). The amount of data to be stored, analyzed, generated, or the like may become very large, in particular if a large number of permutations of probe data are to be utilized.

In some embodiments, data fabric 202 may be searched for data, relationships, or indications of one or more target network conditions. For example, a single data fabric 202 may interact with any number of data manipulators 208 for determining a number of conditions of interest of the cellular network. The data manipulators 208 may be functions, primitives (e.g., programmable functions), machine learning models, statistical models, rule-based models, or the like. Output from data manipulators 208 may include real time probe measurements, e.g., service-chained probe data, which may be provided to northbound applications, reporting applications, feedback control, corrective action applications, or the like.

In some embodiments, data fabric 202 may include data from other sources than data collectors 204. Data fabric 202 may include data provided from a number of sources included in probe services 212. Data fabric 202 may include historical data, data received from northbound applications, data received from various interfaces of plug-ins, condition data (e.g., weather data, cellular traffic data, etc.) separate from or in addition to probe data, etc. Data fabric 202 may include data tags, which may be provided by data collectors 204, probe services 212, etc. data fabric 202 may include metadata, which may be provided with probe data, determined and/or provided by prove services 212, or the like. Enabling access of multiple data manipulators 208 to data fabric 202 may enable initiation of many functions, service-chained probe data collectors, or the like by a software-defined network.

In some embodiments, one or more data manipulators 208 may be performed tasks based on abstract probe requests, e.g., provided via adaptive probe data components 210. For example, rather than searching for specific service-chained probe data as output, a data manipulator 208 may be configured to optimize power output, quality of user experience, consistency of experience, or another metric based on manipulations of data fabric 202. One or more northbound applications (e.g., via APIs) may communicate requests of users to data manipulators 208 to enable extractions of service-chained probe data from data fabric 202.

Data collectors 204 may reside on, measure, analyze, or the like any components of a cellular network. Data collectors 204 may be associated with a radio, a distributed unit, transport layer, central unit (e.g., cloud central unit), control plane, or the like. Data collectors 204 may provide one or more data tags to measured data before providing the data to data fabric 202. Data tags may be provided responsive to requests received via adaptive probe data components 210, data manipulators 208, or the like.

Operations of platform 200 may be directed, enabled, programmed, facilitated, or performed by an intelligent data collector, e.g., intelligent data collector 106 of FIG. 1. An intelligent data collector may perform or cause to be performed operations such as probe data collection and tagging (e.g., operations of data collectors 214). An intelligent data collector may perform or cause to be performed operations including data manipulation, processing, providing, or executing machine learning models, etc. (e.g., operations of data manipulators 208). An intelligent data collector may perform or cause to be performed operations including programming of probes, causing probes to generate data tags, causing probes to generate data, translating requests for service-chained probe data into usable (e.g., programmatic) form, etc. (e.g., operations of adaptive probe data components 210). An intelligent data collector may perform or cause to be performed operations including providing metadata, historical data, etc., e.g., operations of service-chained probe data.

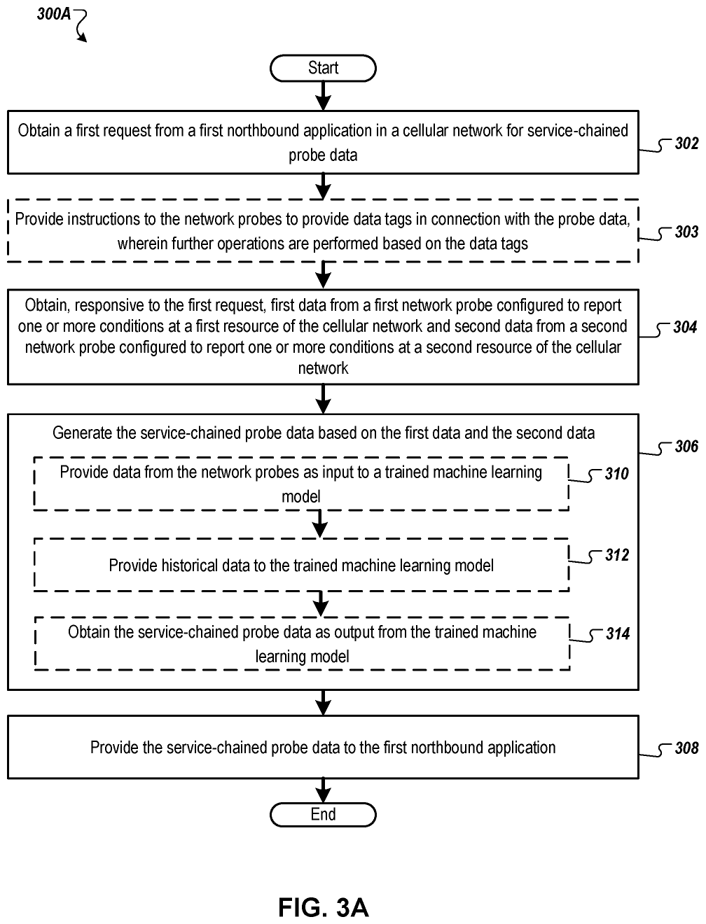

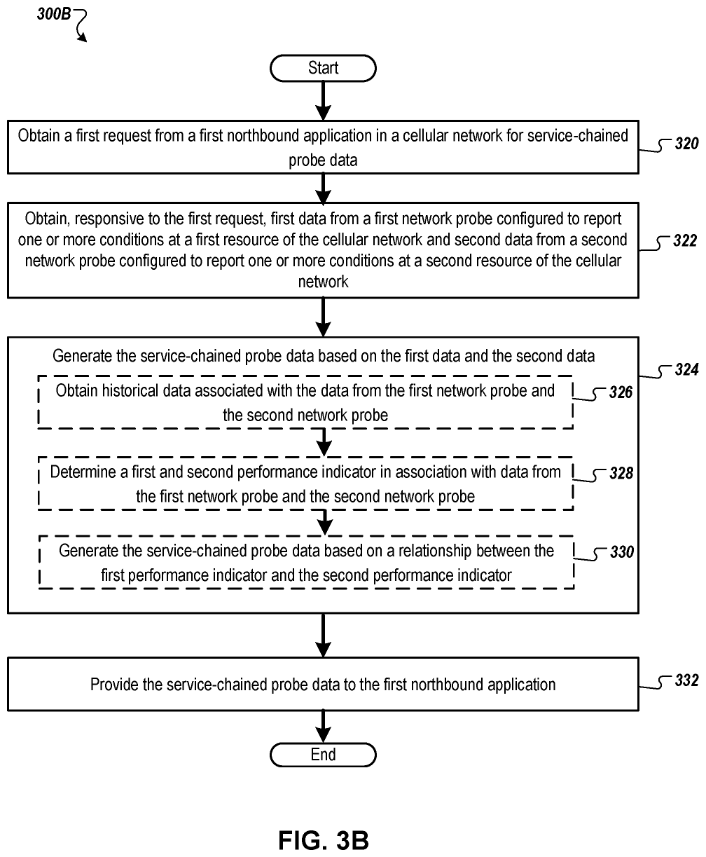

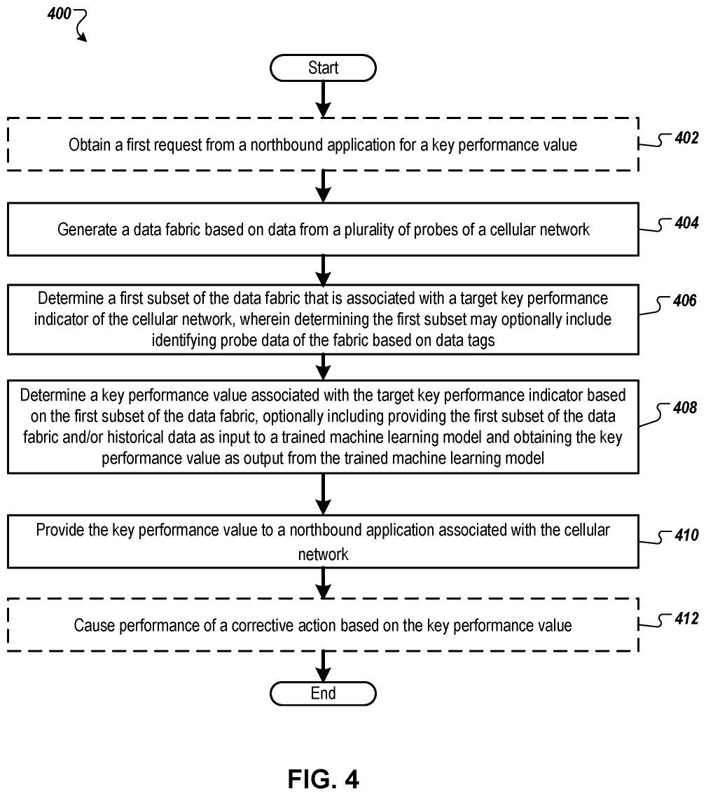

FIGS. 3A-B and FIG. 4 are flow diagrams of methods 300A, 300B, and 400 associated with training and utilizing machine learning models, according to certain embodiments. Methods 300A-B and 400 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 300A-B and 400 may be performed, in part, by components of platform 100. Methods 300A-B and 400 may be performed by intelligent data collector 106, adaptive probe data components 210, data manipulators 208, etc. In some embodiments, a non-transitory machine-readable storage medium stores instructions that when executed by a processing device (e.g., of intelligent data collector 106, of platform 100, etc.) cause the processing device to perform one or more of methods 300A-B and 400.

For simplicity of explanation, methods 300A-B and 400 are depicted and described as a series of operations. However, operations in accordance with this disclosure can occur in various orders and/or concurrently and with other operations not presented and described herein. Furthermore, not all illustrated operations may be performed to implement methods 300A-B and 400 in accordance with the disclosed subject matter. In addition, those skilled in the art will understand and appreciate that methods 300A-B and 400 could alternatively be represented as a series of interrelated states via a state diagram or events.

FIG. 3A is a flow diagram of a method 300A for providing service-chained probe data to a target application, according to some embodiments. Operations of method 300A may be performed by components of a cellular, network, an intelligent data collector, a probe controller, or the like. At block 302, processing logic obtains a first request from a first northbound application in a cellular network for service-chained probe data. The request may be for data generated based on one or more probes of the cellular network.

At block 303, processing logic optionally provides instructions to the first network probe and the second network probe to provide data tags in association with the probe data. Further operations of method 300A may optionally be performed based on the data tags. The data tags may be used in providing probe data to functions for service-chaining. The data tags may be used in routing service-chained probe data to one or more northbound applications. The data tags may be used in correlating related data together, such as data tags associated with data from multiple probes for use in generating service-chained probe data, historical data to be used in generating service-chained probe data, or the like. The data tags may be used in providing additional data such as contextual data along with probe data. The data tags may be indicative of conditions of measurement of the probe data, conditions affecting network hardware of the cellular network, indicative of a type or size of a data packet associated with the probe data measurement, or the like.

At block 304, processing logic obtains, responsive to the first request, first data from a first network probe configured to report one or more conditions at a first resource of the cellular network. The processing logic further obtains second data from a second network probe configured to report one or more conditions at a second resource of the cellular network. The resources may be any resources of a cellular network. The conditions may include data flow, data traffic, network slice conditions, processing or computational device load, data storage device conditions, or the like.

At block 306, processing logic generates the service-chained probe data based on the first data and the second data. The service-chained probe data may be generated by a function from data collected by a number of probes of the cellular network. The service-chained probe data may be provided to functions based on intelligent data collection, based on data tags, or the like. The service-chained probe data may be generated based on historical data.

Blocks 310 through 314 describe optional operations for generating service-chained probe data, according to some embodiments. At block 310, processing logic provides data from the network probes as input to a trained machine learning model. In some embodiments, the trained machine leaning model may be configured to receive as input probe data, and generate as output service-chained probe data based on the input data. In some embodiments, the machine learning model may be configured to generate predictive data indicative of performance root causes, recommended corrective actions, or the like (e.g., the service-chained probe data may be indicative of performance of the cellular network, causes for low performance of the cellular network, recommended corrective actions for the cellular network, etc.).

At block 312, processing logic optionally provides historical data to the trained machine learning model. In some embodiments, a machine learning model may receive probe data as input, and not receive historical data as input. Data tagging may be utilized in determining probe data and/or historical data to provide to the machine learning model. The machine learning model may be configured to determine service-chained probe data based on historical data and input probe data (which may be preprocessed, e.g., to generate features from the probe data). At block 314, processing logic obtains the service-chained probe data as output from the trained machine learning model.

At block 308, processing logic provides the service-chained probe data to the first northbound application. The northbound application may perform reporting operations, e.g., for reporting conditions of the cellular network. The northbound application may be a feedback control application, e.g., for updating one or more parameters of the cellular network. Updating parameters of the cellular network may include adjusting power output of radios, adjusting antenna directionality, adjusting radio resource allocation, adjusting processing device resource allocation, adjusting one or more network slices, or the like.

FIG. 3B is a flow diagram of a method 300B for providing service-chained probe data, according to some embodiments. At block 320, processing logic obtains a first request from a first northbound application in a cellular network for service-chained probe data. Operations of block 320 may share one or more features with operations of block 302 of FIG. 3A.

At block 322, processing logic obtains, responsive to the first request, first data from a first network probe configured to report one or more conditions at a first resource of the cellular network and second data from a second network probe configured to report one or more conditions at a second resource of the cellular network. Operations of block 322 may share one or more features with operations of block 304 of FIG. 3A.

At block 324, processing logic generates the service-chained probe data based on the first data and the second data. Operations of blocks 326 through 330 are optional operations included in generation of the service-chained probe data, according to some embodiments. At block 326, processing logic obtains historical data associated with the data from the first network probe and the second network probe (e.g., the first data and the second data). The historical data may be obtained from a historical data store. The historical data may be labeled, e.g., classified with an associated network problem, condition, or the like. The historical data may be utilized in generating service-chained probe data, in generating predictive data, in generating recommended corrective actions, or the like.

At block 328, processing logic optionally determines a first and second performance indicator in association with data from the first network probe and the second network probe. At block 330, processing logic generates the service-chained probe data based on a relationship between the first performance indicator and the second performance indicator. At block 332, processing logic provides the service-chained probe data to the first northbound application.

FIG. 4 is a flow diagram of a method 400 for generating data output based on a data fabric of probe data, according to some embodiments. At block 402, processing logic optionally obtains a first request from a northbound application for a key performance value. The first request may include a request for specific probe data, for service-chained probe data, for indications or recommended corrective actions, for predictive data indicative of root causes of one or more performance failures, or other metrics that may be indicated by probe data. In some embodiments, a request from a northbound application may be generated or enabled by use of a trained machine learning model for interpreting language requests from a user into service-chained probe data requests.

At block 404, processing logic generates a data fabric based on data from a plurality of probes of a cellular network. The data fabric may include probe data. The data fabric may include data tagging. The data fabric may include metadata. The data fabric may include other data, such as data indicative of conditions of the cellular network, contextual data, etc.

At block 406, processing logic determines a first subset of the data fabric that is associated with a target key performance indicator of the cellular network. The first subset may be a small portion of the data fabric, may be a large portion of the data fabric, etc. In some embodiments, a machine learning model may utilize an entire data fabric (e.g., based on all probes of a cellular network) for determining key performance indicator values, predictive data, or the like. Optionally determining the first subset may include identifying probe data of the fabric based on data tags, e.g., tags indicating a request for the probe data from one or more northbound applications.

At block 408, processing logic determines a key performance value associated with the target key performance indicator based on the first subset of the data fabric. Determining the key performance value may include providing the first subset of the data fabric to one or more models, such as a machine learning model, a statistical model, a rule-based model, or the like. Determining the key performance value may include providing historical data to the model, e.g., historical data from the same or similar probes as data of the data fabric. Determining the key performance value may include obtaining the key performance value as output from the one or more models.

At block 410, processing logic provides the key performance value to a northbound application associated with the cellular network. The northbound application may be executed on a processing device of the cellular network. The northbound application may be executed on a processing device that is not included in the cellular network. The northbound application may perform reporting operations, feedback control operations, corrective action operations, user alert operations, maintenance performance and/or scheduling operations, or the like.

At block 412, processing logic optionally causes performance of a corrective action based on the key performance value. For example, feedback control, adjusting one or more parameter of operation of the cellular network, or the like may be performed responsive to the key performance value.

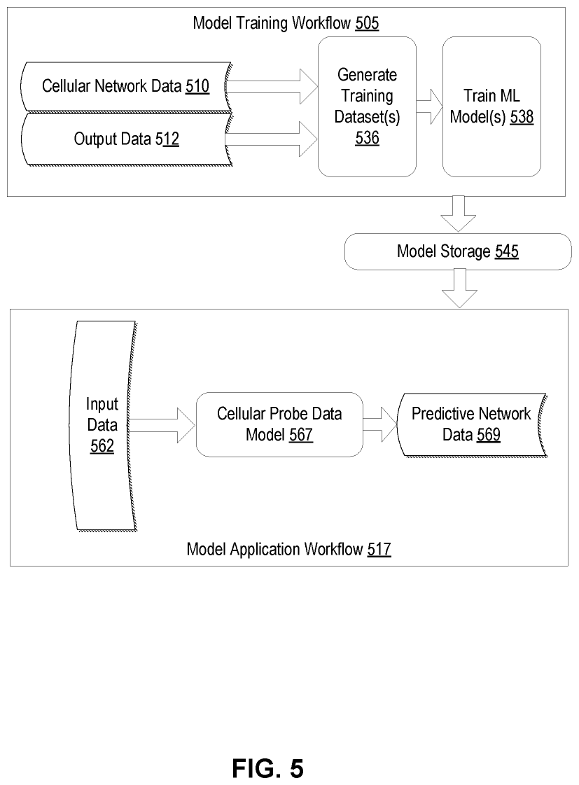

FIG. 5 illustrates a model training workflow 505 and a model application workflow 517 for cellular network data, in accordance with some embodiments of the present disclosure. In embodiments, the model training workflow 505 may be performed at a server or processing device which may or may not be included in architecture of a cellular network (e.g., a 5G network), and the trained models are provided to a northbound which may perform the model application workflow 517. In some embodiments, one or more of an intelligent data collection platform, probe data correlation platform, feedback control application, reporting application, or the like may execute one or more of model training workflow 505 or model application workflow 517. The model training workflow 505 and the model application workflow 517 may be performed by processing logic executed by a processor of a computing device. One or more of these workflows 505, 517 may be implemented, for example, by one or more machine learning modules implemented by components of platform 100 of FIG. 1.

In one embodiment, the trained machine learning model is a decision tree, a random forest model, a support vector machine, or other type of machine learning model.

In one embodiment, the trained machine learning model is an artificial neural network (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

The trained machine learning model may be periodically or continuously retrained to achieve continuous learning and improvement of the trained machine learning model. The model may generate an output based on an input, an action may be performed based on the output, and a result of the action may be measured. In some instances, the result of the action is measured within seconds or minutes, and, in some instances, it takes longer to measure the result of the action. For example, one or more additional processes may be performed before a result of the action can be measured. The action and the result of the action may indicate whether the output was a correct output and/or a difference between what the output should have been and what the output was. Accordingly, the action and the result of the action may be used to determine a target output that can be used as a label for the measurements. Once the result of the action is determined, the input (e.g., probe data), the output of the trained machine learning model (e.g., recommended corrective actions), and the target result (e.g., correction of a condition of the cellular network not satisfying a target threshold) actual measured result (e.g., measured condition of the network) may be used to generate a new training data item. The new training data item may then be used to further train the trained machine learning model. This retraining process may be performed by components of a software defined cellular network in embodiments.

The model training workflow 505 is to train one or more machine learning models (e.g., deep learning models) to perform one or more classifying, segmenting, detection, recognition, decision, etc., tasks associated with a cellular network. The model application workflow 517 is to apply the one or more trained machine learning models to perform the classifying, segmenting, detection, recognition, determining, etc. tasks for generating data in association with the cellular network, such as service-chained probe data, predictive data, instructions for generating service-chained probe data (e.g., based on natural language input), etc.

Various machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In embodiments, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are as follows:
a. Generation of service-chained probe data based on measured probe data—As discussed previously, relationships between probes that are available in a cellular network and performance indicators of interest may be complex, non-linear, or the like. A machine learning model may be capable of predicting cellular network performance by providing values of one or more key performance indicators based on data from a number of probes of the network, without a subject matter expert explicitly defining all relationships between the probe data. The service-chained probe data may include classifications (e.g., of service quality, of network performance, etc.), predicted root causes, recommended actions to be taken by the software defined network, recommended maintenance, or actions to be taken by users or technicians, or the like.
b. Generation of service-chained probe data based on a data fabric—In some embodiments, a data fabric or a subset of a data fabric may be provided to a trained machine learning model to generate service-chained probe data. Providing a data fabric may enable a machine learning model to generate data based on any correlations found in probe data of the data fabric, without restriction to probe data expected by a user to correspond to a target performance of the cellular network.
c. Generation of service-chained probe data requests based on natural language—In some embodiments, a machine learning model (e.g., executed by a northbound application) may receive as input a natural language request, and may translate the natural language request into a machine-readable request for service-chained probe data, e.g., by generating a function to match the request, by selecting a function to match the request, by causing a function to be executed or probe data to be collected at a specific time, frequency, or duration to match the request, or the like.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset.

For the model training workflow 505, a training dataset containing hundreds, thousands, tens of thousands, hundreds of thousands or more cellular network data 510 (e.g., probe data, historical probe data, service-chained data requests, etc.) should be used to form a training dataset. In embodiments, the training dataset may also include associated outcome data 512 (e.g., associated key performance indicator values, associated corrective actions, associated machine-readable service-chained probe data requests, etc.) for forming a training dataset, where each data point and/or associated configuration may include various labels or classifications of one or more types of useful information. This data may be processed to generate one or multiple training datasets 536 for training of one or more machine learning models.

To effectuate training, processing logic inputs the training dataset(s) 536 into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the cellular network data 510 and output data 512 into the machine learning model one at a time. In some embodiments, the training of the machine learning model includes tuning the model to receive cellular network data 510 and output predictive data (e.g., predictions of network performance). The machine learning model processes the input to generate an output. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce.

Accordingly, the output may include one or more predictions or inferences. For example, an output prediction or inference may include service-chained probe data, indications of cellular network performance, or the like. Processing logic may cause one or more updates to the cellular network based on the output. Processing logic may provide service-chained probe data to one or more northbound applications. Processing logic may provide requests for service-chained probe data to components of the network, such as an intelligent data collector.

Processing logic may compare the generated output against a target output (e.g., a label corresponding to the “correct answer”) and determine whether a threshold criterion is met (e.g., threshold similarity between the generated output and target output). Processing logic determines an error (i.e., a classification error) based on the differences between the generated output and the target output. Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria are met if accuracy of the machine learning model has stopped improving. If the stopping criterion has not been met, further training is performed. If the stopping criterion has been met, training May be complete. Once the machine learning model is trained, a reserved portion of the training dataset may be used to test the model.

As an example, in one embodiment, a machine learning model (e.g., cellular probe data model 567) is trained to determine service-chained probe data (e.g., an indicator of performance quality of a cellular network). A similar process may be performed to train machine learning models to perform other tasks such as those set forth above. A set of many (e.g., thousands to millions) sets of probe data may be collected and performance indicators may be determined based on the probe data.

Once one or more trained machine learning models 538 are generated, they may be stored in model storage 545, and may be added to a cellular network, e.g., a northbound application, an intelligent data collector, a probe data manipulation function, or the like. The cellular network may then use the one or more trained ML models 538 as well as additional processing logic to implement an automatic mode, in which user manual input of information is minimized or even eliminated in some instances.

For model application workflow 517, according to one embodiment, input data 562 may be input into cellular probe data model 567, which may include a trained neural network. Based on the input data 562, cellular probe data model 567 outputs information indicating a service-chained probe data. Cellular probe data model 567 generates predictive network data 569, which may include service-chained probe data, recommended actions, service-chained probe data requests, predicted root causes, or the like.

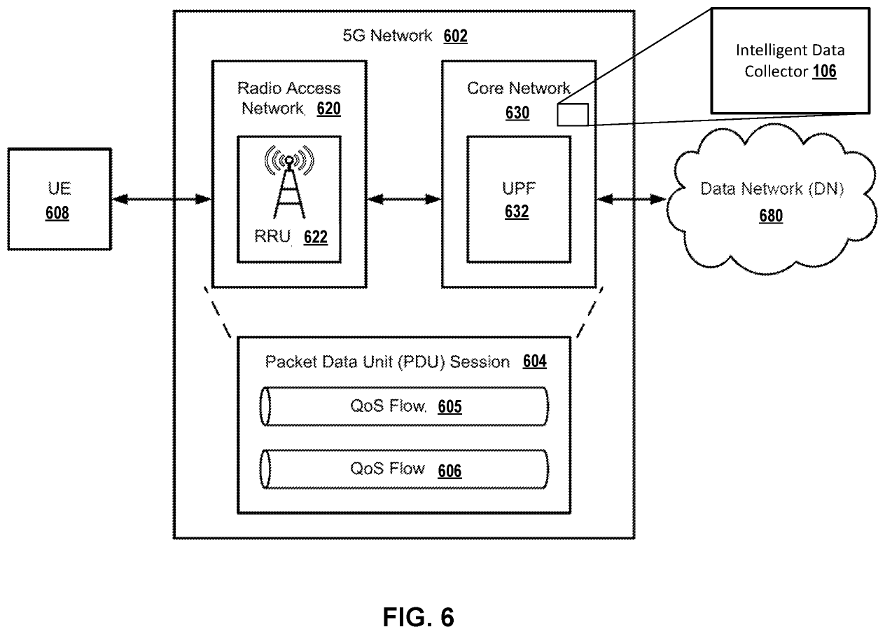

FIG. 6 depicts a 5G network 602 including a radio access network (RAN) 620 and a core network 630 according to at least one embodiment. In at least one embodiment, the intelligent data collector 106 of FIG. 1 can be implemented in the core network 630 to provide service-chained probe data as described herein. The RAN 620 can include a new-generation radio access network (NG-RAN) that uses the 5G new radio interface (NR). The 5G network 602 connects user equipment (UE) 608 to the data network (DN) 680 using the RAN 620 and the core network 630. The data network 680 can include the Internet, a local area network (LAN), a wide area network (WAN), a private data network, a wireless network, a wired network, or a combination of networks. The UE 608 can include an electronic device with wireless connectivity or cellular communication capability, such as a mobile phone or handheld computing device. In at least one example, the UE 608 can include a 5G smartphone or a 5G cellular device that connects to the RAN 620 via a wireless connection. The UE 608 can include one of a number of UEs not depicted that are in communication with the RAN 620. The UEs may include mobile and non-mobile computing devices. The UEs may include laptop computers, desktop computers, an Internet-of-Things (IoT) devices, and/or any other electronic computing device that includes a wireless communications interface to access the RAN 620.

The RAN 620 includes a remote radio unit (RRU) 622 for wirelessly communicating with UE 608. The remote radio unit (RRU) 622 can include a Radio Unit (RU) and may include one or more radio transceivers for wirelessly communicating with UE 608. The remote radio unit (RRU) 622 may include circuitry for converting signals sent to and from an antenna of a Base Station into digital signals for transmission over packet networks. The RAN 620 may correspond with a 5G radio Base Station that connects user equipment to the core network 630. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 608.

The core network 630 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and APIs. In at least one embodiment, the intelligent data collector 106 can be implemented in control plane (CP) functions executed by core network 630. In at least one embodiment, an architecture in which software is composed of small independent services that communicate over well-defined APIs may be used for implementing some of the core network functions. For example, control plane (CP) network functions for performing session management may be implemented as containerized applications. A container-based implementation may offer improved scalability and availability over other approaches.

The primary core network functions can include the access and mobility management function (AMF), the session management function (SMF), and the user plane function (UPF). In at least one embodiment, the intelligent data collector can be implemented in the AMF. The UPF (e.g., UPF 632) may perform packet processing including routing and forwarding, quality of service (QOS) handling, and packet data unit (PDU) session management. The UPF may serve as an ingress and egress point for user plane traffic and provide anchored mobility support for user equipment. For example, the UPF 632 may provide an anchor point between the UE 608 and the data network 680 as the UE 608 moves between coverage areas. The AMF may act as a single-entry point for an UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 620, such as a Distributed Unit (DU) and a centralized unit (CU), may need to be deployed at a cell site or in a local data center (LDC) that is in close proximity to a cell site such that the latency requirements are satisfied (e.g., such that the one-way latency from the cell site to the DU component or CU component is less than 1.2 ms).

In some embodiments, the Distributed Unit (DU) and the centralized unit (CU) of the RAN 620 may be co-located with the remote radio unit (RRU) 622. In other embodiments, the Distributed Unit (DU) and the remote radio unit (RRU) 622 may be co-located at a cell site and the centralized unit (CU) may be located within a local data center (LDC).

The 5G network 602 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 602. In some cases, the 5G network 602 may support customized policy configuration and enforcement between network slices per service level agreements (SLAs) within the radio access network (RAN) 620. User equipment, such as UE 608, may connect to multiple network slices at the same time (e.g., eight different network slices). In one embodiment, a PDU session, such as PDU session 604, may belong to only one network slice instance.

In some cases, the 5G network 602 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 630 may include a set of network elements that are configured to offer various data and telecommunications services to subscribers or end users of user equipment, such as UE 608. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 602 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIG. 6, the core network 630 includes a user plane function (UPF) 632 for transporting IP data traffic (e.g., user plane traffic) between the UE 608 and the data network 680 and for handling packet data unit (PDU) sessions with the data network 680. The UPF 632 can include an anchor point between the UE 608 and the data network 680. The UPF 632 may be implemented as a software process or application running within a virtualized infrastructure or a cloud-based compute and storage infrastructure. The 5G network 602 may connect the UE 608 to the data network 680 using a PDU session 604, which can include part of an overlay network.

The PDU session 604 may utilize one or more quality of service (QOS) flows, such as QoS flows 605 and 606, to exchange traffic (e.g., data and voice traffic) between the UE 608 and the data network 680. The one or more QoS flows can include the finest granularity of QoS differentiation within the PDU session 604. The PDU session 604 may belong to a network slice instance through the 5G network 602. To establish user plane connectivity from the UE 608 to the data network 680, an AMF that supports the network slice instance may be selected and a PDU session via the network slice instance may be established. In some cases, the PDU session 604 may be of type IPv4 or IPv6 for transporting IP packets. The RAN 620 may be configured to establish and release parts of the PDU session 604 that cross the radio interface.

The RAN 620 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 608, over a geographic area. Some cells may correspond with stationary coverage areas and other cells may correspond with coverage areas that change over time (e.g., due to movement of a mobile RRU).

In some cases, the UE 608 may be capable of transmitting signals to and receiving signals from one or more RRUs within the network of cells over time. One or more cells may correspond with a cell site. The cells within the network of cells may be configured to facilitate communication between UE 608 and other UEs and/or between UE 608 and a data network, such as data network 680. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

UPF 632 may be responsible for routing and forwarding user plane packets between the RAN 620 and the data network 680. Uplink packets arriving from the RAN 620 may use a general packet radio service (GPRS) tunneling protocol (or GTP) to reach the UPF 632. The GPRS tunneling protocol for the user plane may support multiplexing of traffic from different PDU sessions by tunneling user data over the interface between the RAN 620 and the UPF 632.

The UPF 632 may remove the packet headers belonging to the GTP tunnel before forwarding the user plane packets towards the data network 680. As the UPF 632 may provide connectivity towards other data networks in addition to the data network 680, the UPF 632 must ensure that the user plane packets are forwarded towards the correct data network. Each GTP tunnel may belong to a specific PDU session, such as PDU session 604. Each PDU session may be set up towards a specific data network name (DNN) that uniquely identifies the data network to which the user plane packets should be forwarded. The UPF 632 may keep a record of the mapping between the GTP tunnel, the PDU session, and the DNN for the data network to which the user plane packets are directed.

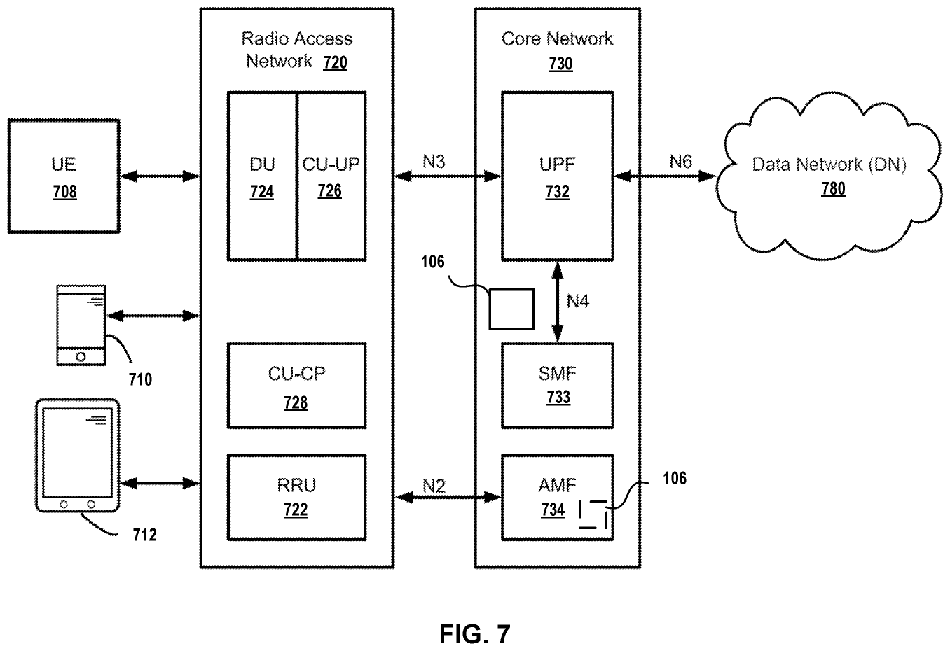

Downlink packets arriving from the data network 680 are mapped onto a specific QoS flow belonging to a specific PDU session before forwarded towards the appropriate RAN 620. A QOS flow may correspond with a stream of data packets that have equal quality of service (QOS). A PDU session may have multiple QoS flows, such as the QoS flows 605 and 606 that belong to PDU session 604. The UPF 632 may use a set of service data flow (SDF) templates to map each downlink packet onto a specific QoS flow. The UPF 632 may receive the set of SDF templates from a session management function (SMF), such as the SMF 733 depicted in FIG. 7, during setup of the PDU session 604. The SMF may generate the set of SDF templates using information provided from a policy control function (PCF), such as the PCF 735 depicted in FIG. 7. The UPF 632 may track various statistics regarding the volume of data transferred by each PDU session, such as PDU session 604, and provide the information to an SMF.

FIG. 7 depicts a RAN 720 and a core network 730 for providing a communications channel (or channel) between user equipment and data network 780 according to at least one embodiment. In at least one embodiment, the intelligent data collector 106 can be implemented in the core network 730 to provide service-chained probe data as described herein. The communications channel can include a pathway through which data is communicated between the UE 708 and the data network 780. The user equipment in communication with the RAN 720 includes UE 708, mobile phone 710, and mobile computing device 712. The user equipment may include a set of electronic devices, including mobile computing device and non-mobile computing device.

The core network 730 includes network functions such as an access and mobility management function (AMF) 734, a session management function (SMF) 733, and a user plane function (UPF) 732. The AMF may interface with user equipment and act as a single-entry point for a UE connection. The AMF may interface with the SMF to track user sessions. The AMF may interface with a network slice selection function (NSSF) not depicted to select network slice instances for user equipment, such as UE 708. When user equipment is leaving a first coverage area and entering a second coverage area, the AMF may be responsible for coordinating the handoff between the coverage areas whether the coverage areas are associated with the same radio access network or different radio access networks.

The UPF 732 may transfer downlink data received from the data network 780 to user equipment, such as UE 708, via the RAN 720 and/or transfer uplink data received from user equipment to the data network 780 via the RAN 720. An uplink can include a radio link though which user equipment transmits data and/or control signals to the RAN 720. A downlink can include a radio link through which the RAN 720 transmits data and/or control signals to the user equipment.

The RAN 720 may be logically divided into a remote radio unit (RRU) 722, a Distributed Unit (DU) 724, and a centralized unit (CU) that is partitioned into a CU user plane portion (CU-UP) 726 and a CU control plane portion (CU-CP) 728. The CU-UP 726 may correspond with the centralized unit for the user plane and the CU-CP 728 may correspond with the centralized unit for the control plane. The CU-CP 728 may perform functions related to a control plane, such as connection setup, mobility, and security. The CU-UP 726 may perform functions related to a user plane, such as user data transmission and reception functions. Decoupling control signaling in the control plane from user plane traffic in the user plane may allow the UPF 732 to be positioned in close proximity to the edge of a network compared with the AMF 734. In at least one embodiment, the intelligent data collector 106 can be implemented in the AMF 734. As a closer geographic or topographic proximity may reduce the electrical distance, this means that the electrical distance from the UPF 732 to the UE 708 may be less than the electrical distance of the AMF 734 to the UE 708. The RAN 720 may be connected to the AMF 734, which may allocate temporary unique identifiers, determine tracking areas, and select appropriate policy control functions (PCFs) for user equipment, via an N2 interface. The N3 Interface may be used for transferring user data (e.g., user plane traffic) from the RAN 720 to the user plane function UPF 732 and may be used for providing low-latency services using edge computing resources. The electrical distance from the UPF 732 (e.g., located at the edge of a network) to user equipment, such as UE 708, may impact the latency and performance services provided to the user equipment. The UE 708 may be connected to the SMF 733 via an N1 interface not depicted, which may transfer UE information directly to the AMF 734. The UPF 732 may be connected to the data network 780 via an N6 interface. The N6 interface may be used for providing connectivity between the UPF 732 and other external or internal data networks (e.g., to the Internet). The RAN 720 may be connected to the SMF 733, which may manage UE context and network handovers between Base Stations, via the N2 interface. The N2 interface may be used for transferring control plane signaling between the RAN 720 and the AMF 734.

The RRU 722 may perform physical layer functions, such as employing orthogonal frequency-division multiplexing (OFDM) for downlink data transmission. In some cases, the DU 724 may be located at a cell site (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different cell sites (or cellular Base Stations) and 180 different RRUs.

In some embodiments, the RAN 720 or portions of the RAN 720 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 724 and CU-UP 726 may be executed as virtual instances within a data center environment that provides single-digit millisecond latencies (e.g., less than 2 ms) from the virtual instances to the UE 708.

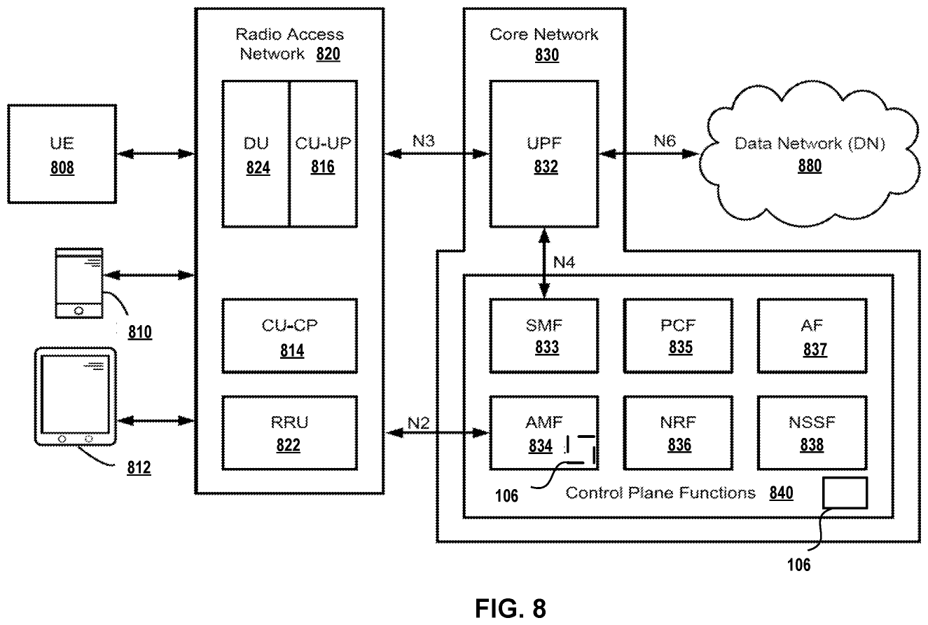

FIG. 8 depicts a RAN 820 and a core network 830 for providing a communications channel (or channel) between user equipment and data network 880 according to at least one embodiment. The core network 830 includes UPF 832 for handling user data in the core network 830. Data is transported between the RAN 820 and the core network 830 via the N3 Interface. The data may be tunneled across the N3 Interface (e.g., IP routing may be done on the tunnel header IP address instead of using end user IP addresses). This may allow for maintaining a stable IP anchor point even though UE 1108 may be moving around a network of cells or moving from one coverage area into another coverage area. The UPF 832 may connect to external data networks, such as the data network 880 via the N6 interface. The data may not be tunneled across the N6 interface as IP packets may be routed based on end user IP addresses. The UPF 832 may connect to the SMF 833 via the N4 interface.

As depicted, the core network 830 includes a group of control plane functions including SMF 833, AMF 834, PCF 835, NRF 836, AF 837, and NSSF 838. In at least one embodiment, the intelligent data collector 106 can be implemented in the control plane functions 840 to provide service-chained probe data as described herein. The SMF 833 may configure or control the UPF 832 via the N4 interface. For example, the SMF 833 may control packet forwarding rules used by the UPF 832 and adjust QoS parameters for QoS enforcement of data flows (e.g., limiting available data rates). In some cases, multiple SMF/UPF pairs may be used to simultaneously manage user plane traffic for a particular user device, such as UE 808. For example, a set of SMFs may be associated with UE 808, where each SMF of the set of SMFs corresponds with a network slice. The SMF 833 may control the UPF 832 on a per end user data session basis, in which the SMF 833 may create, update, and remove session information in the UPF 832.

In some cases, the SMF 833 may select an appropriate UPF for a user plane path by querying the NRF 836 to identify a list of available UPFs and their corresponding capabilities and locations. The SMF 833 may select the UPF 832 based on a physical location of the UE 808 and a physical location of the UPF 832 (e.g., corresponding with a physical location of a data center in which the UPF 832 is running). The SMF 833 may also select the UPF 832 based on a particular network slice supported by the UPF 832 or based on a particular data network that is connected to the UPF 832. The ability to query the NRF 836 for UPF information eliminates the need for the SMF 833 to store and update the UPF information for every available UPF within the core network 830.

In some embodiments, the SMF 833 may query the NRF 836 to identify a set of available UPFs for a packet data unit (PDU) session and acquire UPF information from a variety of sources, such as the AMF 834 or the UE 808. The UPF information may include a location of the UPF 832, a location of the UE 808, and/or mobile phone 810, mobile computing device 812, etc., the UPF's dynamic load, the UPF's static capacity among UPFs supporting the same data network, and the capability of the UPF 832.

The RAN 820 may provide separation of the centralized unit for the control plane (CU-CP) 814 and the centralized unit for the user plane (CU-UP) 816 functionalities while supporting network slicing. The CU-CP 814 may obtain resource utilization and latency information from the DU 824 and/or the CU-UP 816, and select a CU-UP to pair with the DU 824 based on the resource utilization and latency information in order to configure a network slice. Network slice configuration information associated with the network slice may be provided to the UE 808 for purposes of initiating communication with the UPF 832 using the network slice. RAN 820 may further include RRU 822.

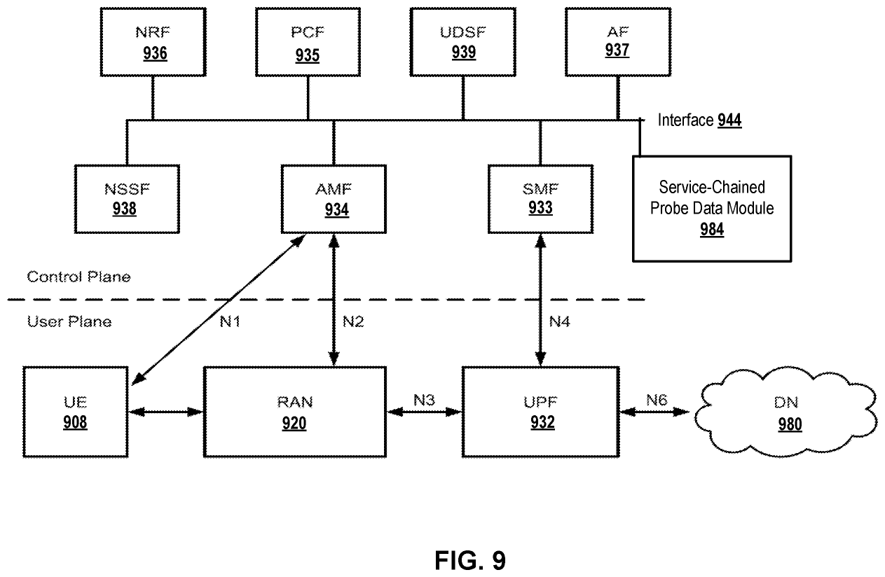

FIG. 9 depicts network functions interacting between user and control planes according to at least one embodiment. The logical connections between the network functions depicted in FIG. 9 should not be interpreted as direct physical connections. The RAN 920 is connected to the user plane function UPF 932 via interface N3. The UPF 932 is connected to the data network 980 via the N6 interface. In some cases, the data network 980 may represent an edge computing network or resources, such as a mobile edge computing (MEC) network. UE 908 connects to the AMF 934, which is responsible for authentication and authorization of access requests, as well as mobility management functions via the N1 interface.

AMF 934 may communicate with other network functions through an interface 944 using application programming interfaces (APIs). The SMF 933 can include a network function that is responsible for the allocation and management of IP addresses that are assigned to the UE 908, as well as the selection of the UPF 932 for traffic associated with a particular PDU session for the UE 908. The SMF 933 may also communicate with other network functions through the interface 944 using application programming interfaces (APIs). Each of the network functions NRF 936, PCF 935, unstructured data storage function (UDSF) 939, AF 937, NSSF 938, AMF 934, and SMF 933 may communicate with each other via the interface 944 using application programming interfaces (APIs). The unstructured data storage function (UDSF) 939 may provide service interfaces to store, update, read, and delete network function data. Using the UDSF 939, network functions such as the PCF 935, SMF 933, and AMF 934 may remain stateless or primarily stateless. In at least one embodiment, a service-chained probe data module 984 can communication with other network functions through the interface 944. The service-chained probe data module 984 can be provided at least in part by the intelligent data collector 106 as described herein.

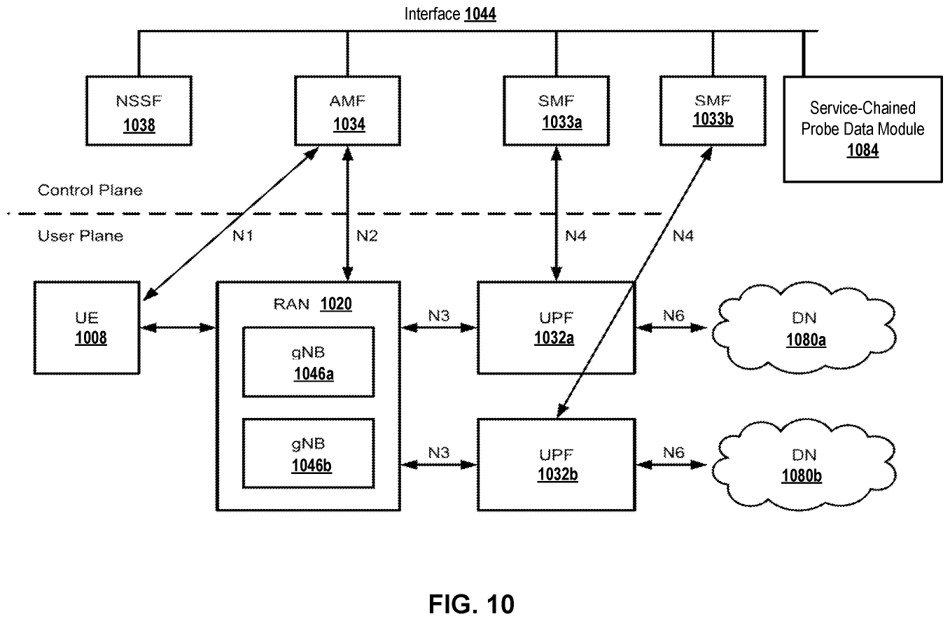

FIG. 10 depicts network functions interacting between user and control planes according to at least one embodiment. As depicted, UPFs 1032a-1032b (also referred to as UPFs 1032) are in communication with data networks (DNs) 1080a-1080b (also referred to as DNs 1080). In some cases, a set of UPFs 1032 may be connected in series between the RAN 1020 and a set of DNs 1080. The RAN 1020 may include gNBs 1046a-1046b (also referred to as gNBs 1046). Each gNB 1046 can include at least a DU, a CU-UP, and a CU-CP.

Multiple PDU sessions to different data networks may be accommodated through the use of multiple UPFs in parallel. For the sake of clarity, some of the network functions depicted in FIG. 10 have been omitted, however it should be understood that the omitted network functions may interact with the network functions depicted in FIG. 10. Each UPF 1032a-1032b may be associated with a PDU session, and may connect to a corresponding SMF 1033a-1033b over an N4 interface to receive session control information. If the UE 1008 has multiple PDU sessions active, then each PDU session may be supported by a different UPF 1032, each of which may be connected to an SMF 1033 over an N4 interface. It should also be understood that any of the network functions may be virtualized within a network, and that the network itself may be provided as a network slice. Network functions communicating via interface 1044 may further include NSSF 1038, AMF 1034, and service-chained probe data module 1084, as described previously.

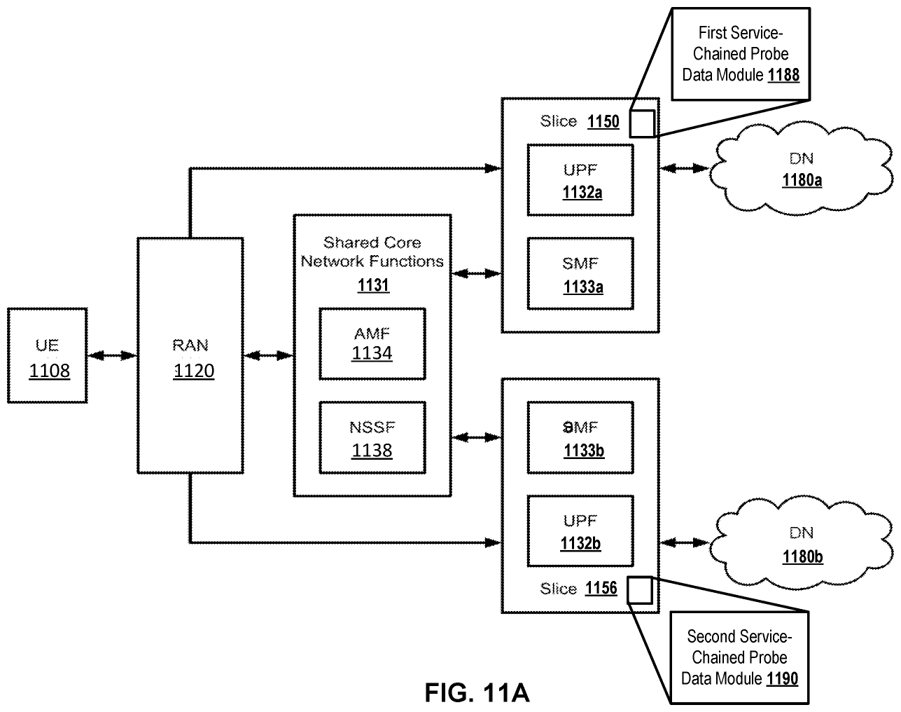

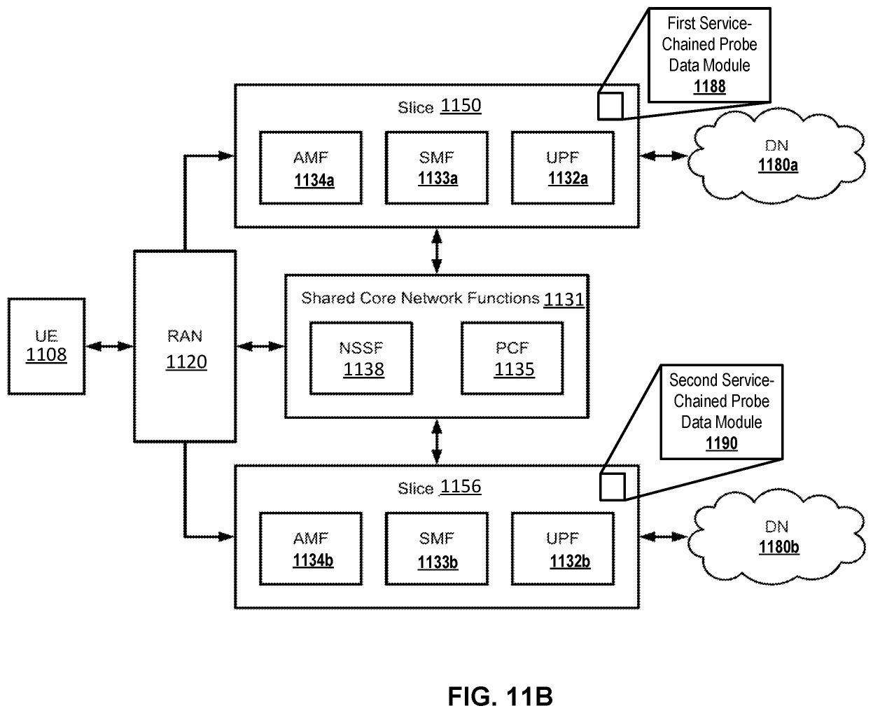

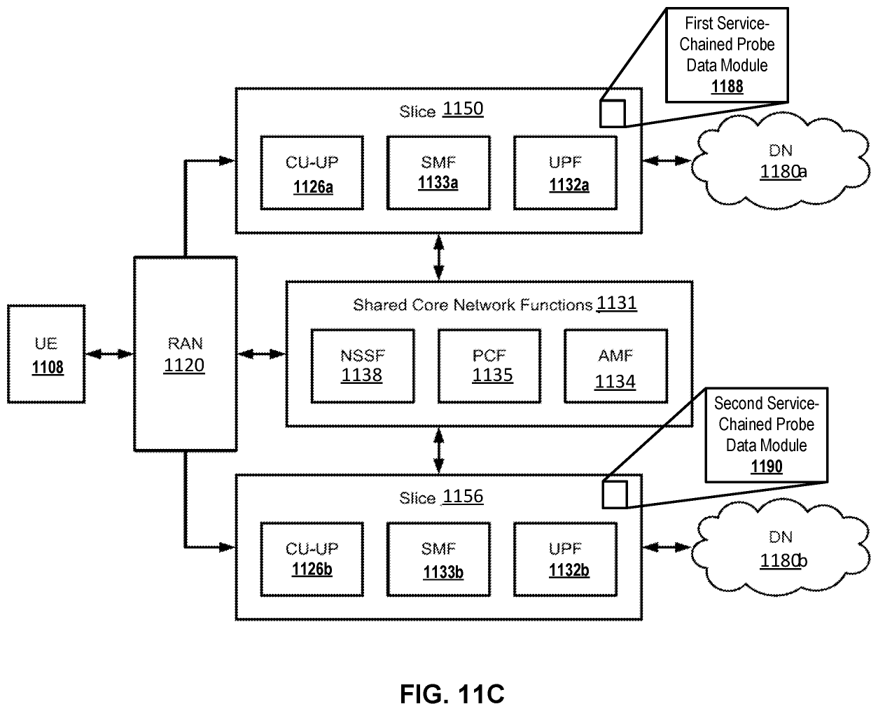

FIG. 11A depicts network slices 1150 and 1156 (also referred to as network slices) sharing a set of shared core network functions 1131 according to at least one embodiment. The set of shared core network functions 1131 includes AMF 1134 and NSSF 1138. The radio access network (RAN) 1120 may support differentiated handling of traffic between isolated network slices 1150 and 1156 for the UE 1108. The network slice selection function (NSSF) 1138 within the shared core network functions 1131 may support the selection of network slice instances to serve the UE 1108. In some cases, network slice selection may be determined by the network (e.g., using either NSSF 1138 or AMF 1134) based on network slice policy. The UE 1108 may simultaneously connect to data networks 1180a and 1180b via the network slices 1150 and 1156 to support different latency requirements. In at least one embodiment, a first service-chained probe data module 1188 can operate in a first slice 1150, and a second service-chained probe data module 1190 can operate in a second slice 1156.

FIG. 11B depicts network slices 1150 and 1156 after updates have been made based on changed to the network slice policy according to at least one embodiment. As depicted, the network slices 1150 and 1156 share a set of shared core network functions 1131 that may include a PCF 1135 and NSSF 1138. Each network slice includes an AMF 1134, an SMF 1133, and a UPF 1132.

FIG. 11H depicts network slices 1150 and 1156 after updates have been made based on changed to the network slice policy according to at least one embodiment. As depicted, the network slices 1150 and 1156 share a set of shared core network functions 1131 that includes AMF 1134, PCF 1135, and NSSF 1138. Each network slice includes a CU-UP 1216, SMF 1133, and a UPF 1132; accordingly, network slice 1150 includes CU-UP 1126a, SMF 1133a, and UPF 1132a and network slice 1156 includes CU-UP 1126b, SMF 1133b, and UPF 1132b.

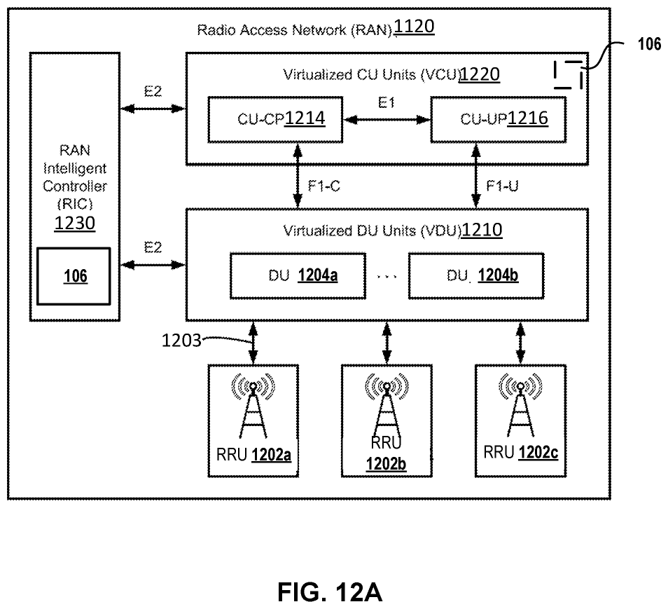

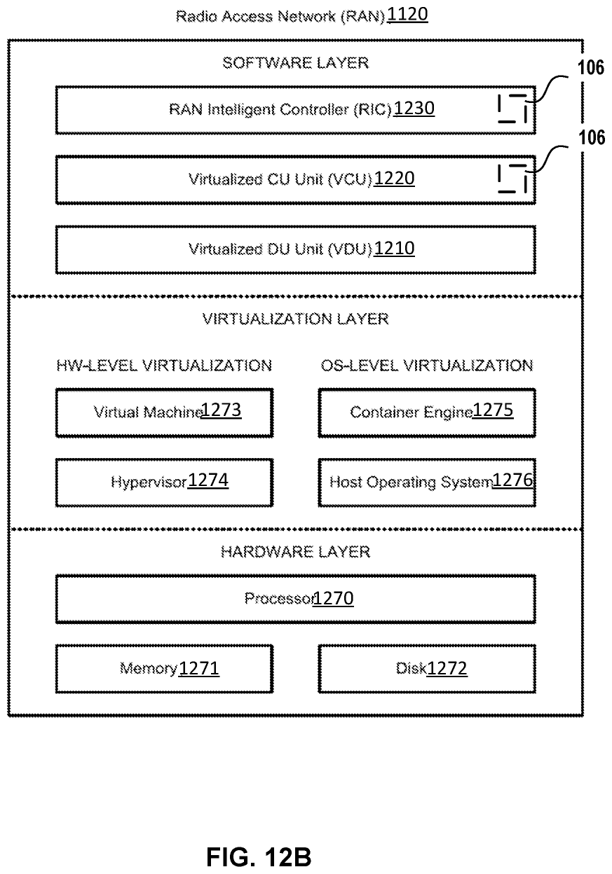

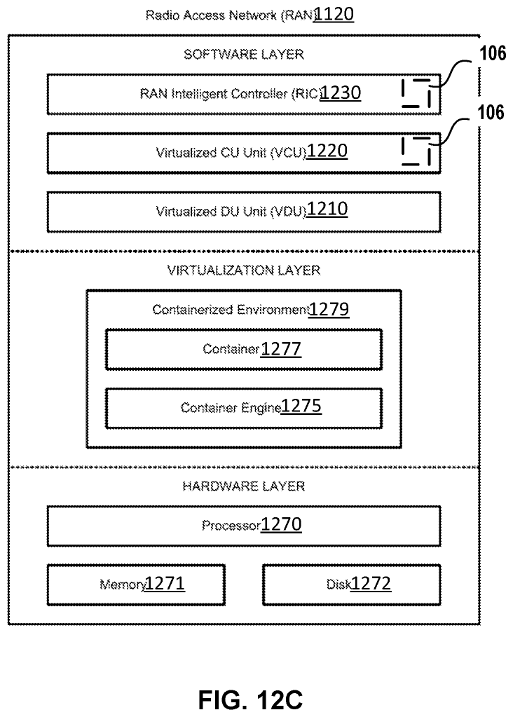

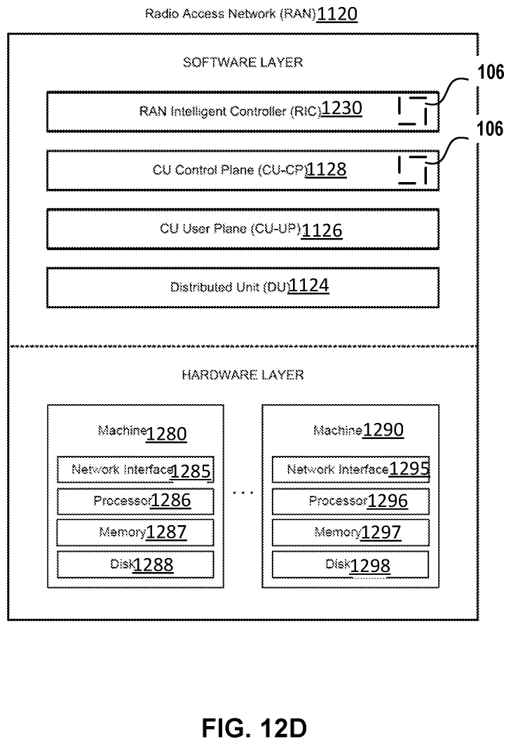

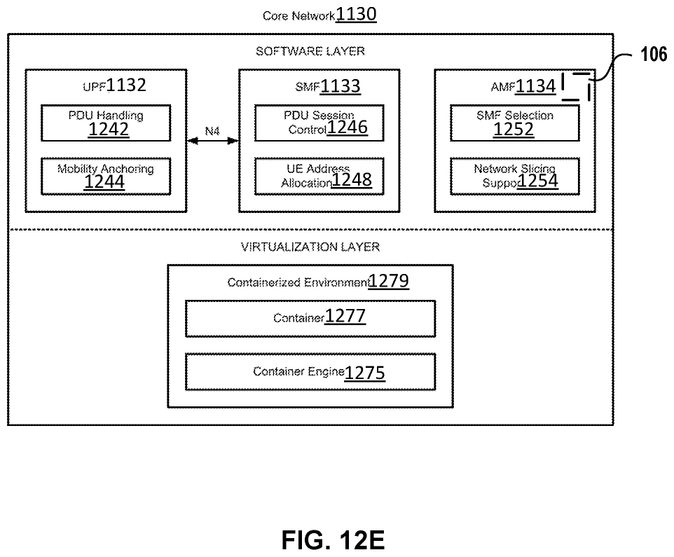

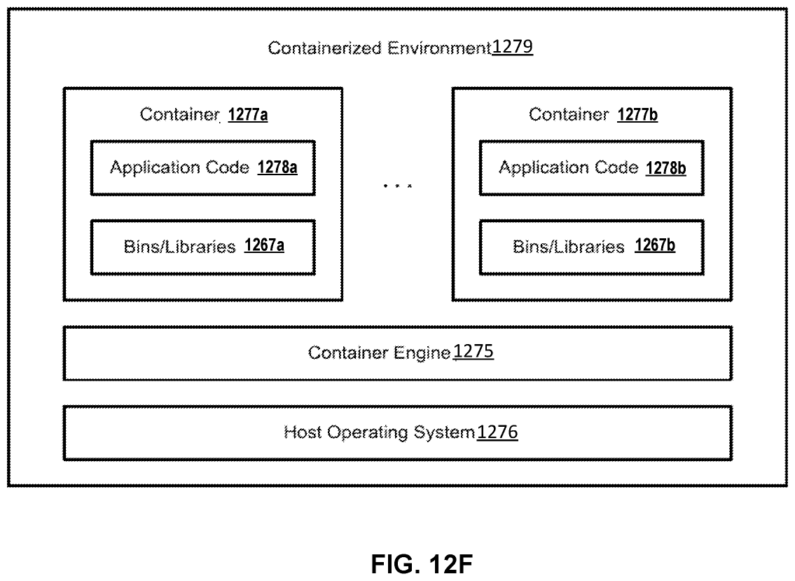

FIG. 12A depicts a RAN 1120 according to at least one embodiment. The RAN 1120 includes virtualized CU units (VCU) 1220, virtualized DU units (VDU) 1210, remote radio units (RRUs) 1202a-1202c, and a RAN intelligent controller (RIC) 1230. In at least one embodiment, the intelligent data collector 106 can be implemented in the RIC 1230 to provide service-chained probe data as described herein. The virtualized DU units 1210 can include virtualized versions of distributed units (DUs) 1204. The distributed unit (DU) 1204 can include a logical node configured to provide functions for the radio link control (RLC) layer, the medium access control (MAC) layer, and the physical layer (PHY) layers. The virtualized CU units 1220 can include virtualized versions of centralized units (CUs) including a centralized unit for the user plane CU-UP 1126 and a centralized unit for the control plane CU-CP 1214. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane CU-CP 1214 can include a logical node configured to provide functions of the control plane part of the RRC and PDCP. The centralized unit for the user plane CU-UP 1216 can include a logical node configured to provide functions of the user plane part of the SDAP and PDCP. Virtualizing the control plane and user plane functions allows the centralized units (CUs) to be consolidated in one or more data centers on RAN-based open interfaces. In at least one embodiment, the intelligent data collector 106 can be implemented in the VCU 1220 to provide service-chained probe data as described herein.

The remote radio units (RRUs) 1202a-1202c may correspond with different cell sites. A single DU may connect to multiple RRUs via a fronthaul interface 203. The fronthaul interface 203 may provide connectivity between DUs and RRUs. For example, DU 1204a may connect to 18 RRUs via the fronthaul interface 1203. A centralized units (CUs) may control the operation of multiple DUs via a midhaul F1 Interface that includes the F1-C and F1-U interfaces. The F1 Interface may support control plane and user plane separation, and separate the Radio Network Layer and the Transport Network Layer. In one example, the centralized unit for the control plane CU-CP 1214 may connect to ten different DUs within the virtualized DU units 1210. In this case, the centralized unit for the control plane CU-CP 1214 may control ten DUs and 180 RRUs. A single Distributed Unit (DU) 1204 may be located at a cell site or in a local data center. Centralizing the Distributed Unit (DU) 1204 at a local data center or at a single cell site location instead of distributing the DU 1204 across multiple cell sites may result in reduced implementation costs.

The centralized unit for the control plane CU-CP 1214 may host the radio resource control (RRC) layer and the control plane part of the packet data convergence control (PDCP) layer. The E1 Interface may separate the Radio Network Layer and the Transport Network Layer. The CU-CP 1214 terminates the E1 Interface connected with the centralized unit for the user plane CU-UP 1216 and the F1-C interface connected with the distributed units (DUs) 1204. The centralized unit for the user plane CU-UP 1216 hosts the user plane part of the packet data convergence control (PDCP) layer and the service data adaptation protocol (SDAP) layer. The CU-UP 1216 terminates the E1 Interface connected with the centralized unit for the control plane CU-CP 1214 and the F1-U interface connected with the distributed units (DUs) DU 1204. The distributed units (DUs) 1204 may handle the lower layers of the baseband processing up through the packet data convergence control (PDCP) layer of the protocol stack. The interfaces F1-C and E1 may carry signaling information for setting up, modifying, relocating, and/or releasing a UE context.

The RAN intelligent controller (RIC) 1230 may control the underlying RAN elements via the E2 Interface. The E2 Interface connects the RAN intelligent controller (RIC) 1230 to the distributed units (DUs) 1204 and the centralized units CU-CP 1214 and CU-UP 1216. The RAN intelligent controller (RIC) 1230 can include a near-real time RIC. A non-real-time RIC (NRT-RIC) not depicted can include a logical node allowing non-real time control rather than near-real-time control and the near-real-time RIC 1230 can include a logical node allowing near-real-time control and optimization of RAN elements and resources on the bases of information collected from the distributed units (DUs) 1204 and the centralized units CU-CP 1214 and CU-UP 1216 via the E2 Interface.

The virtualization of the distributed units (DUs) 1204 and the centralized units CU-CP 1214 and CU-UP 1216 allows various deployment options that may be adjusted over time based on network conditions and network slice requirements. In at least one example, both a Distributed Unit (DU) 1204 and a corresponding centralized unit CU-UP 1216 may be implemented at a cell site. In another example, a Distributed Unit (DU) 1204 may be implemented at a cell site and the corresponding centralized unit CU-UP 1216 may be implemented at a local data center (LDC). In another example, both a Distributed Unit (DU) 1204 and a corresponding centralized unit CU-UP 1216 may be implemented at a local data center (LDC). In another example, both a Distributed Unit (DU) 1204 and a corresponding centralized unit CU-UP 1216 may be implemented at a cell site, but the corresponding the centralized unit CU-CP 1214 may be implemented at a local data center (LDC). In another example, a Distributed Unit (DU) 1204 may be implemented at a local data center (LDC) and the corresponding centralized units CU-CP 1214 and CU-UP 1216 may be implemented at an edge data center (EDC).

In some embodiments, network slicing operations may be communicated via the E1, F1-C, and F1-U interfaces of the RAN 1120. For example, CU-CP 1214 may select the appropriate DU 1204 and CU-UP 1216 entities to serve a network slicing request associated with a particular service level agreement (SLA).

FIG. 12B depicts a RAN 1120 according to at least one embodiment. As depicted, the RAN 1120 includes hardware-level components and software-level components. The hardware-level components include one or more processors 1270, one or more memory 1271, and one or more disks 1272. The one or more memory 1271 can be communicatively coupled with and readable by the one or more processors 1270 (or processing devices). The one or more memory 1271 can have stored therein processor-readable instructions when, when executed by the one or more processors 1270, cause the one or more processors 1270 to perform operations described herein. The software-level components include software applications, such as a RAN intelligent controller (RIC) 1230, virtualized CU unit (VCU) 1220, and virtualized DU unit (VDU) 1210. The software-level components may be run using the hardware-level components or executed using processor and storage components of the hardware-level components. In one example, one or more of the RIC 1230, VCU 1220, and VDU 1210 may be run using the processor 1270, memory 1271, and disk 1272. In another example, one or more of the RIC 1230, VCU 1220, and VDU 1210 may be run using a virtual processor and a virtual memory that are themselves executed or generated using the processor 1270, memory 1271, and disk 1272.

The software-level components also include virtualization layer processes, such as virtual machine 1273, hypervisor 1274, container engine 1275, and host operating system 1276. The hypervisor 1274 can include a native hypervisor (or bare-metal hypervisor) or a hosted hypervisor (or type 2 hypervisor). The hypervisor 1274 may provide a virtual operating platform for running one or more virtual machines, such as virtual machine 1273. A hypervisor can include software that creates and runs virtual machine instances. Virtual machine 1273 may include a set of virtual hardware devices, such as a virtual processor, a virtual memory, and a virtual disk. The virtual machine 1273 may include a guest operating system that has the capability to run one or more software applications, such as the RAN intelligent controller (RIC) 1230. The virtual machine 1273 may run the host operating system 1276 upon which the container engine 1275 may run. A virtual machine, such as virtual machine 1273, may include one or more virtual processors.

A container engine 1275 may run on top of the host operating system 1276 in order to run multiple isolated instances (or containers) on the same operating system kernel of the host operating system 1276. Containers may perform virtualization at the operating system level and may provide a virtualized environment for running applications and their dependencies. The container engine 1275 may acquire a container image and convert the container image into running processes. In some cases, the container engine 1275 may group containers that make up an application into logical units (or pods). A pod may contain one or more containers and all containers in a pod may run on the same node in a cluster. Each pod may serve as a deployment unit for the cluster. Each pod may run a single instance of an application.

In order to scale an application horizontally, multiple instances of a pod may be run in parallel. A “replica” may refer to a unit of replication employed by a computing platform to provision or deprovision resources. Some computing platforms may run containers directly and therefore a container can include the unit of replication. Other computing platforms may wrap one or more containers into a pod and therefore a pod can include the unit of replication.

A replication controller may be used to ensure that a specified number of replicas of a pod are running at the same time. If less than the specified number of pods are running (e.g., due to a node failure or pod termination), then the replication controller may automatically replace a failed pod with a new pod. In some cases, the number of replicas may be dynamically adjusted based on a prior number of node failures. For example, if it is detected that a prior number of node failures for nodes in a cluster running a particular network slice has exceeded a threshold number of node failures, then the specified number of replicas may be increased (e.g., increased by one). Running multiple pod instances and keeping the specified number of replicas constant may prevent users from losing access to their application in the event that a particular pod fails or becomes inaccessible.

In some embodiments, a virtualized infrastructure manager not depicted may run on the RAN 1120 in order to provide a centralized platform for managing a virtualized infrastructure for deploying various components of the RAN 1120. The virtualized infrastructure manager may manage the provisioning of virtual machines, containers, and pods. The virtualized infrastructure manager may also manage a replication controller responsible for managing a number of pods. In some cases, the virtualized infrastructure manager may perform various virtualized infrastructure related tasks, such as cloning virtual machines, creating new virtual machines, monitoring the state of virtual machines, and facilitating backups of virtual machines. In at least one embodiment, the intelligent data collector 106 can be implemented in the RIC 1230 or the VCU 1220 to provide service-chained probe data as described herein.

FIG. 12C depicts the RAN 1120 of FIG. 12B in which the virtualization layer includes a containerized environment 1279 according to at least one embodiment. The containerized environment 1279 includes a container engine 1275 for instantiating and managing application containers, such as container 1277. Containerized applications can include applications that run in isolated runtime environments (or containers). The containerized environment 1279 may include a container orchestration service for automating the deployments of containerized applications. The container 1277 may be used to deploy microservices for running network functions. The container 1277 may run DU components and/or CU components of the RAN 1120. The containerized environment 1279 may be executed using hardware-level components or executed using processor and storage components of the hardware-level components. In one example, the containerized environment 1279 may be run using the processor 1270, memory 1271, and disk 1272. In another example, the containerized environment 1279 may be run using a virtual processor and a virtual memory that are themselves executed or generated using the processor 1270, memory 1271, and disk 1272. In at least one embodiment, the intelligent data collector 106 can be implemented in the RIC 1230 or the VCU 1220 to provide service-chained probe data as described herein.

FIG. 12D depicts a RAN 1120 according to at least one embodiment. As depicted, the RAN 1120 includes hardware-level components and software-level components. The hardware-level components include a set of machines (e.g., physical machines) that may be grouped together and presented as a single computing system or a cluster. Each machine of the set of machines can include a node in a cluster (e.g., a failover cluster).

As depicted, the set of machines include machine 1280 and machine 1290. The machine 128080 includes a network interface 1285, processor 1286, memory 1287, and disk 1288 all in communication with each other. Processor 1286 allows machine 1280 to execute computer readable instructions stored in memory 1287 to perform processes described herein. Processor 1286 may include one or more processing units, such as one or more CPUs and/or one or more graphics processing units (GPUs). Memory 1287 can include one or more types of memory (e.g., RAM, SRAM, DRAM, ROM, EEPROM, or Flash). The disk 1288 can include a hard disk drive and/or a solid-state drive. Similarly, the machine 1290 includes a network interface 1295, processor 1296, memory 1297, and disk 1298 all in communication with each other. Processor 1296 allows machine 1290 to execute computer readable instructions stored in memory 1297 to perform processes described herein. In some embodiments, the set of machines may be used to implement a failover cluster. In some cases, the set of machines may be used to run one or more virtual machines or to execute or generate a containerized environment, such as the containerized environment 1279 depicted in FIG. 12C.

The software-level components include a RAN intelligent controller (RIC) 1230, CU control plane (CU-CP) 1214, CU user plane (CU-UP) 1216, and Distributed Unit (DU) 1204. In one embodiment, the software-level components may be run using a dedicated hardware server. In another embodiment, the software-level components may be run using a virtual machine running or containerized environment running on the set of machines. In another embodiment, the software-level components may be run from the cloud (e.g., the software-level components may be deployed using a cloud-based compute and storage infrastructure). In at least one embodiment, the intelligent data collector 106 can be implemented in the RIC 1230 or the VCU 1220 to provide service-chained probe data as described herein.

FIG. 12E depicts a core network 1130 according to at least one embodiment. As depicted, the core network 1130 includes implementation for core network functions UPF 1132, SMF 1133, and AMF 1134. The core network 1130 may be used to provide Internet access for user equipment via a radio access network, such as the RAN 1120 in FIG. 12C. The AMF 1134 may be configured to host various functions including SMF selection 1252 and network slicing support 1254. The UPF 1132 may be configured to host various functions including mobility anchoring 1244, packet data unit (PDU) handling 1242, and QoS handling for the user plane. The SMF 1133 may be configured to host various functions including UE IP address allocation and management 1248, selection and control of user plane functions, and PDU session control 1246. The core network functions may be run using containers within the containerized environment 1279 that includes a container engine 1275 for instantiating and managing application containers, such as container 1277. In some embodiments, the containerized environment 1279 may be executed or generated using a set of machines as depicted in FIG. 12D or may be executed or generated using hardware-level components, such as the processor 1270, memory 1271, and disk 1272 depicted in FIG. 12C. In at least one embodiment, the intelligent data collector 106 can be implemented in the AMF 1134 to provide a service-chained probe data as described herein.

FIG. 12F depicts a containerized environment 1279 that includes a container engine 1275 running on top of a host operating system 1276 according to at least one embodiment. The container engine 1275 may manage or run containers 1277 on the same operating system kernel of the host operating system 1276. The container engine 1275 may acquire a container image and convert the container image into one or more running processes. In some cases, the container engine 1275 may group containers that make up an application into logical units (or pods). A pod may contain one or more containers and all containers in a pod may run on the same node in a cluster. Each container 1277 may include application code 1278 and application dependencies 1267, such as operating system libraries, required to run the application code 1278. Containers allow portability by encapsulating an application within a single executable package of software that bundles application code 1278 together with the related configuration files, binaries, libraries, and dependencies required to run the application code 1278.

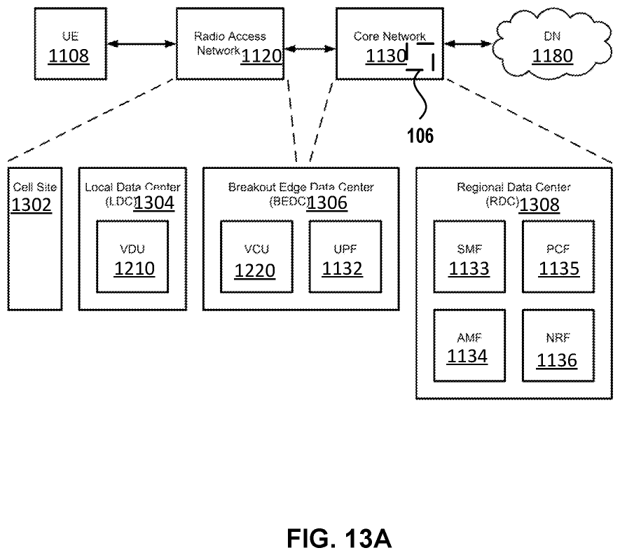

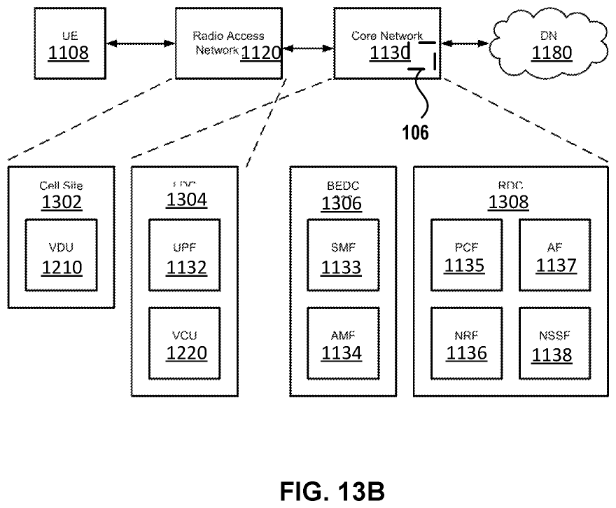

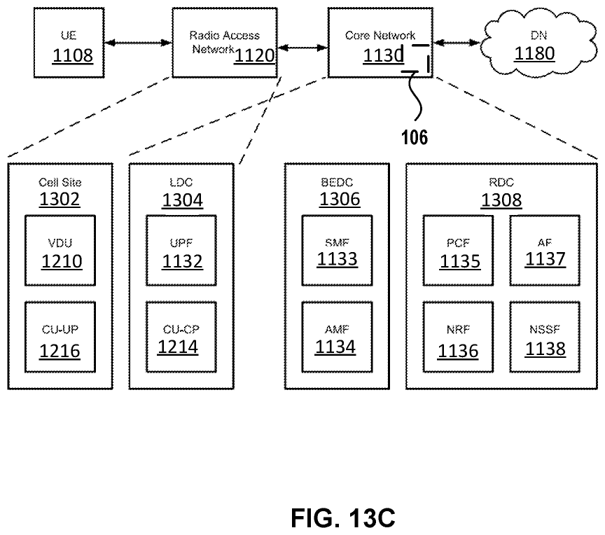

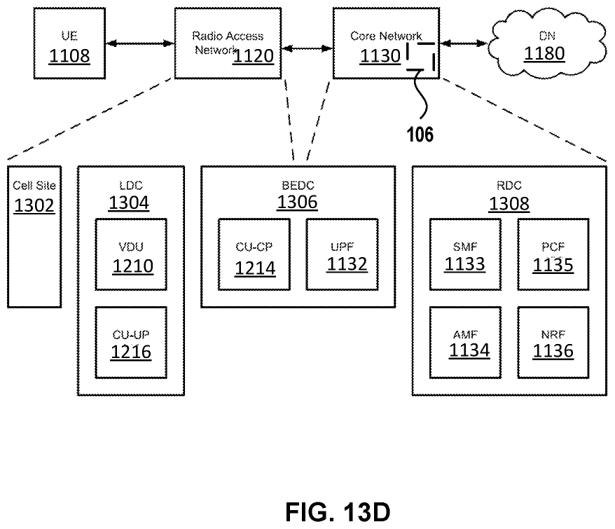

FIG. 13A depicts a 5G network including a RAN 1120 and a core network 1130 according to at least one embodiment. In at least one embodiment, the intelligent data collector 106 can be implemented in the core network 1130 to provide service-chained probe data as described herein. The RAN 1120 and the core network 1130 allow user equipment UE 1108 to transfer data to the data network 1180 and/or to receive data from the data network 1180. As depicted, the VDU 1210 and VCU 1220 components of the RAN 1120 may be implemented using different data centers within a data center hierarchy that includes a local data center (LDC) 1304 that is a first electrical distance away from the cell site 1302, a breakout edge data center (BEDC) 1306 that is a second electrical distance greater than the first electrical distance away from the cell site 1302, and a regional data center (RDC) 1308 that is a third electrical distance greater than the second electrical distance away from the cell site 1302. The local data center (LDC) 1304 may correspond with a first one-way latency from the cell site 1302. The breakout edge data center (BEDC) 1306 may correspond with a second one-way latency greater than the first one-way latency from the cell site 1302. The regional data center (RDC) 1308 may correspond with a third one-way latency greater than the second one-way latency from the cell site 1302. The cell site 1302 may include a cell tower or one or more remote radio units (RRUs) for sending and receiving wireless data transmissions. In some cases, the cell site 1302 may correspond with a macrocell site or a small cell site, such as a microcell site.

In some cases, a data center may refer to a networked group of computing and storage devices that may run applications and services. The data center may include hardware servers, storage systems, routers, switches, firewalls, application-delivery controllers, cooling systems, and power subsystems. A data center may refer to a collection of computing and storage resources provided by on-premises physical servers and/or virtual networks that support applications and services across pools of physical infrastructure. Within a data center, a set of services may be connected together to provide a computing and storage resource pool upon which virtualized entities may be instantiated. Multiple data centers may be interconnected with each other to form larger networks consisting of pooled computing and storage resources connected to each other by connectivity resources. The connectivity resources may take the form of physical connections, such as Ethernet or optical communications links, and may include wireless communication channels as well. If two different data centers are connected by a set of different communication channels, the links may be combined together using various techniques including the formation of link aggregation groups (LAGs). A LAG can include a logical interface that uses the link aggregation control protocol (LACP) to aggregate multiple connections at a single direct connect endpoint.

As depicted in FIG. 13A, the VDU 1210 is running within the local data center (LDC) 1304 and the VCU 1220 is running within the breakout edge data center (BEDC) 1306. The core network functions SMF 1133, AMF 1134, PCF 1135, and NRF 1136 are running within the regional data center (RDC) 1308. The user plane function UPF 1132 is running within the breakout edge data center (BEDC) 1306. In some embodiments, the breakout edge data center (BEDC) 1306 can include an edge data center at an edge of a network managed by a cloud service provider.

One technical benefit of utilizing edge computing to move network functions closer to user equipment is that data communication latency may be reduced. The reduced latency may enable real-time interactivity between user equipment, such as UE 1108 in FIG. 11A, and cloud-based services. Edge computing, including mobile edge computing, may refer to the arrangement of computing and associated storage resources at locations closer to the “edge” of a network in order to reduce data communication latency to and from user equipment (e.g., end user mobile phones). Some technical benefits of positioning edge computing resources closer to UEs include low latency data transmissions (e.g., under 5 ms), real-time (or near real-time) operations, reduced network backhaul traffic, and reduced energy consumption. The edge computing resources may be located within on-premises data centers (on-prem), near or on cell towers, and at network aggregation points within the radio access networks and core networks. Examples of applications and services that may be executed using edge computing include virtual network functions and 5G-enabled network services. The virtual network functions can include software-based network functions that are executed using the edge computing resources.

Technical benefits of dynamically assigning one or more virtualized network functions (e.g., a user plane function) to different locations or servers for execution within a data center hierarchy is that latency, power, and availability requirements may be optimized for multiple network slices over time. Technical benefits of adjusting the server location or the data center location of one or more virtualized network functions (e.g., a user plane function) for a network slice over time is that the network slice may be dynamically reconfigured to adapt to changes in latency, power, and availability requirements. In one example, a network slice may have a first configuration corresponding with a low-latency configuration in which a user plane function is deployed at a cell site and then subsequently be reconfigured to a second configuration corresponding with a low-power configuration in which the user plane function is redeployed at a breakout edge data center location.

The location of the UPF 1132 (e.g., whether the UPF 1132 is deployed at the local data center 1304 or the breakout edge data center 1306) places constraints on the transport network not depicted connecting the UPF 1132 with the core network 1130. For example, depending on the UPF placement location, the transport network for the backhaul (the N3 Interface) may either be minimized if the UPF is placed closer to the VCU 1220 (or closer to the RAN edge) or maximized if the UPF is placed farther away from the VCU 1220.

The applications and services running on the edge computing resources may communicate with a large number of UEs that may experience connectivity failures (e.g., due to battery life limitations or latency issues) over time. The applications and services may utilize heartbeat tracking techniques to manage device connectivity to the UEs.

FIG. 13B depicts the 5G network depicted in FIG. 13A in which the VDU 1210 has been moved to run at the cell site 1302, the VCU 1220 and the UPF 1132 have been moved to run at the local data center (LDC) 1304, and the SMF 1133 and the AMF 1134 have been moved to run in the breakout edge data center (BEDC) 1306 according to at least one embodiment. In some embodiments, intelligent data controller 106 can be implemented in core network 1130 for generating service-chained probe data, as described herein. A virtualized network function may be moved from a first data center to a second data center within a data center hierarchy by transferring an application or program code for the virtualized network function from a first server within the first data center to a second server within the second data center. In some embodiments, a second virtual processor that is instantiated and run within the second data center may acquire instructions or program code associated with a virtualized network function prior to a first virtual processor that previously run the virtualized network function within the first data center being deleted. The shifting of network functions closer to the cell site 1302 and/or closer to user equipment may have been performed in response to changes in a service level agreement (SLA) or a request to establish a lower-latency network connection from user equipment to a data network. A service level agreement (SLA) may correspond with a service obligation in which penalties may apply if the SLA is violated. In some cases, SLA service metrics may include key performance indicators (KPIs), such as packet loss, latency, and guaranteed bit rate.

In some embodiments, network slices may be reconfigured in order to satisfy traffic isolation requirements, end-to-end latency requirements (e.g., the round-trip time between two end points in a network slice), and throughput requirements for each slice of the network slices. In some cases, the traffic isolation, end-to-end latency, and throughput requirements may vary as a function of a priority level assigned to a given network slice (e.g., whether a network slice have been assigned a high priority or a low priority).

In some embodiments, a first data center and a second data center within a data center hierarchy may both have the same applications or program code stored thereon such that both data centers can run one or more of the same virtualized network functions. In at least one such embodiment, a virtualized network function may be moved from the first data center to the second data center by transferring control or execution of the virtualized network function from the first data center to the second data center without transferring applications or program code.

FIG. 13C depicts the 5G network depicted in FIG. 13B in which the VCU 1220 has been partitioned such that the CU-CP 1214 may run at the local data center (LDC) 1304 and the CU-UP 1216 may be moved to run at the cell site 1302 according to at least one embodiment. The cell site 1302 may include computing and storage resources for running containerized applications. In some embodiments, intelligent data controller 106 can be implemented in core network 1130 for generating service-chained probe data, as described herein.

FIG. 13D depicts the 5G network depicted in FIG. 13C in which the CU-CP 1214 and the UPF 1132 have been moved to run in the breakout edge data center (BEDC) 1306, the VDU 1210 and the CU-UP 1216 have been moved to run at the local data center (LDC) 1304, and the SMF 1133 and the AMF 1134 have been moved to run in the regional data center (RDC) 1308 according to at least one embodiment. Deploying the VDU 1210 and the CU-UP 1216 in the local data center (LDC) 1304 may allow the VDU 1210 to more efficiently support a number of cells sites including the cell site 1302. In some embodiments, intelligent data controller 106 can be implemented in core network 1130 for generating service-chained probe data, as described herein.

A data center hierarchy may include a set of data centers that span across different geographic regions. A region may correspond with a large geographical area in which multiple data centers are deployed to provide different cloud services. Each data center within the region may include a server cluster. A server cluster (or cluster) can include a set of physical machines that are connected together via a network. The cluster may be used to process and store data and to run applications and services in a distributed manner. Applications and data associated with the applications may be replicated or mirrored over a set of machines within a cluster to improve fault tolerance. Each machine in a cluster can include a node in the cluster. In at least one example, the cluster can include a failover cluster.

Geo-redundancy may be achieved by running applications or services across two or more availability zones within the same region. Geo-redundancy may refer to the physical placement of servers or server clusters within geographically diverse data centers to safeguard against catastrophic events and natural disasters.

An availability zone can include a smaller geographical area that is smaller than the large geographical area of the region. Multiple availability zones may reside within a region. An availability zone can include one or more data centers with redundant power, networking, and connectivity within a region.

Each region can include a separate geographical area that does not overlap with any other regions. A logical grouping of one or more data centers within a region may correspond with an availability zone. Each region may include multiple availability zones that can include multiple isolated geographical areas within the region. The data centers within the availability zones of a region may be physically isolated from each other inside the region to improve fault tolerance.

Each availability zone inside a geographical region may utilize its own power, cooling, and networking connections. An application may be deployed across two or more availability zones in order to ensure high availability. In this case, if a first availability zone goes down (e.g., due to a power failure) within a geographical region, then the application may still be accessible and running within a second availability zone. Each availability zone within the geographical region may be connected to each other with high bandwidth, low latency network connections to enable synchronous replication of applications and services across the two or more availability zones.

A local zone may correspond with a small geographical region in which one or more data centers are deployed to provide low latency (e.g., single-digit millisecond latency) applications and services. User equipment that is located within the small geographical region or that is located within a threshold distance (e.g., within two miles) of the small geographical region may be able to provide low latency services. A data center within a local zone may allow a direct private connection to compute and storage resources without requiring access to the Internet. The direct private connection may utilize fiber optic cables to allow a server within the local zone to privately connect to other data centers without requiring access to the Internet.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
obtaining a first request from a first northbound application in a cellular network for service-chained probe data;
obtaining, responsive to the first request, first data from a first network probe configured to report one or more conditions at a first resource of the cellular network and second data from a second network probe configured to report one or more conditions at a second resource of the cellular network;
generating the service-chained probe data based on the first data and the second data; and
providing the service-chained probe data to the first northbound application.

2. The method of claim 1, wherein generating the service-chained probe data comprises:
obtaining historical data in association with the data from the first network probe and the second network probe;
determining a first performance indicator in association with the historical data, and a second performance indicator in association with the data from the first network probe and the second network probe; and
generating the service-chained probe data based on a relationship between the first performance indicator and the second performance indicator.

3. The method of claim 1, wherein generating the service-chained probe data comprises:
providing the data from the first network probe and the second network probe as input to a trained machine learning model; and
obtaining the service-chained probe data as output from the trained machine learning model, wherein the output from the trained machine learning model is based on the data from the first network probe and the second network probe.

4. The method of claim 3, wherein generating the service-chained probe data further comprises providing historical data to the trained machine learning model, wherein the output from the trained machine learning model is further based on the historical data.

5. The method of claim 1, further comprising:
providing instructions to the first network probe to provide a first data tag in connection with the first data; and
providing instructions to the second network probe to provide a second data tag in connection with the second data, wherein obtaining the first data the data from the first network probe and the second data from the second network probe is performed responsive to the first and second data tags.

6. The method of claim 5, wherein the first data tag is indicative of one or more of:
a time of measurement;
a type of data packet;
a size of data packet;
an identifier of the first northbound application; or
a condition affecting network hardware of the cellular network.

7. The method of claim 1, wherein the first network probe comprises a function for performing a measurement of data at one of:
a radio of the cellular network;
a distributed unit;
a central unit;
a data transport layer; or
a control plane.

8. The method of claim 1, wherein the first northbound application is executed by a processing device of the cellular network.

9. The method of claim 1, wherein providing the service-chained probe data to the first northbound application comprises causing the service-chained probe data to be transmitted to a processing device that is not of the cellular network.

10. The method of claim 1, further comprising providing the service-chained probe data and data from a third network probe to a second northbound application responsive to obtaining a second request from the second northbound application.

11. The method of claim 1, wherein the first northbound application is configured to perform a corrective action in view of the service chained probe data, wherein the corrective action comprises one or more of:
adjusting power output of one or more radios of the cellular network;
adjusting antenna directionality of one or more antennas of the cellular network;
adjusting radio resource allocation;
adjusting processing device resource allocation; or
adjusting one or more network slices.

12. A method comprising:
generating a data fabric from data from a plurality of probes of a cellular network;
determining a first subset of the data fabric that is associated with a target key performance indicator of the cellular network;
determining a key performance value associated with the target key performance indicator based on the first subset of the data fabric; and
providing the key performance value to a northbound application associated with the cellular network.

13. The method of claim 12, wherein determining the key performance value comprises:
providing the first subset of the data fabric as input to a trained machine learning model; and
obtaining the key performance value as output from the trained machine learning model based on the first subset of the data fabric.

14. The method of claim 13, wherein determining the key performance value further comprises providing historical data associated with the first subset of the data fabric to the trained machine learning model as input, wherein the output from the trained machine learning model is further based on the historical data.

15. The method of claim 12, further comprising identifying the first subset of the data fabric, wherein identifying the first subset of the data fabric comprises identifying probe data from a first subset of the plurality of probes of the cellular network based on data tags provided by the first subset of the plurality of probes.

16. One or more non-transitory, computer-readable storage media having computer-readable instructions thereon which, when executed by one or more processing devices, cause the one or more processing devices to perform operations comprising:
obtaining a first request from a first northbound application for service-chained probe data, wherein the service-chained probe data comprises data from a first network probe configured to report one or more conditions at a first resource of a cellular network and data from a second network probe configured to report on one or more conditions at a second resource of the cellular network;
obtaining data from the first network probe and the second network probe responsive to the first request;
generating the service-chained probe data based on the data obtained from the first network probe and the second network probe; and
providing the service-chained probe data to the first northbound application.

17. The one or more non-transitory, computer-readable storage media of claim 16, wherein generating the service chained probe data comprises:
obtaining historical data in association with the data from the first network probe and the second network probe;
determining a first performance indicator in association with the historical data, and a second performance indicator in association with the data from the first network probe and the second network probe; and
generating the service-chained probe data based on a relationship between the first performance indicator and the second performance indicator.

18. The one or more non-transitory, computer-readable storage media of claim 16, wherein the operations further comprise:
providing instructions to the first network probe to provide a first data tag in connection with the first data; and
providing instructions to the second network probe to provide a second data tag in connection with the second data, wherein the one or more processing devices obtain the data from the first network probe and the second network probe responsive to the first and second data tags.

19. The one or more non-transitory, computer-readable storage media of claim 16, wherein generating the service-chained probe data comprises:
providing the data from the first network probe and the second network probe as input to a trained machine learning model; and
obtaining the service-chained probe data as output from the trained machine learning model, wherein the output from the trained machine learning model is based on the data from the first network probe and the second network probe.

20. The one or more non-transitory, computer-readable storage media of claim 19, wherein generating the service-chained probe data further comprises providing historical data to the trained machine learning model, wherein the output from the trained machine learning model is further based on the historical data.
